(19) United States
(12) Patent Application Publication
(10) Pub. No.: US 2026/0280636 A1
(43) Pub. Date: Sep. 17, 2026

(54) EARLY INDICATION FOR UPCOMING APERIODIC CHANNEL STATE INFORMATION REPORT REQUEST

(71) Applicant: QUALCOMM Incorporated, San Diego, CA (US)

(72) Inventors: Doohyun SUNG, Basking Ridge, NJ (US); Wooseok NAM, San Diego, CA (US); Tao LUO, San Diego, CA (US)

(21) Appl. No.: 19/082,067

(22) Filed: Mar. 17, 2025

(51) Int. Cl. H04B 7/06; H04W 24/10; H04W 72/231

(52) U.S. Cl. CPC H04B 7/0626; H04W 24/10; H04W 72/231

(57) ABSTRACT

Systems and techniques are provided for wireless communications. For example, a network entity can receive a first message associated with an aperiodic channel state information (CSI) report, wherein the first message indicates a request for the aperiodic CSI report is scheduled. The network entity can generate, based on a measurement configuration indicated by the first message, measurement information for the aperiodic CSI report. The network entity can receive a second message indicative of a request for the aperiodic CSI report. The network entity can transmit, in response to the request, the aperiodic CSI report, wherein the aperiodic CSI report includes the measurement information.

### INTRODUCTION

Aspects of the present disclosure generally relate to wireless communication. In some implementations, examples are described for indications of an upcoming aperiodic channel state information (CSI) report request.

Wireless s communications systems are deployed to provide various telecommunication services, including telephony, video, data, messaging, broadcasts, among others. Wireless communications systems have developed through various generations, including a first-generation analog wireless phone service (1G), a second-generation (2G) digital wireless phone service (including interim 2.5G networks), a third-generation (3G) high speed data, Internet-capable wireless service, a fourth-generation (4G) service (e.g., Long-Term Evolution (LTE), WiMax), and a fifth-generation (5G) service (e.g., New Radio (NR)). There are presently many different types of wireless communications systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile communication (GSM), etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for performing wireless communication. According to at least one illustrative example, a network entity for wireless communication is provided. The network entity includes a processing system, where the processing system is configured to: receive a first message associated with an aperiodic channel state information (CSI) report, wherein the first message indicates a request for the aperiodic CSI report is scheduled; generate, based on a measurement configuration indicated by the first message, measurement information for the aperiodic CSI report; receive a second message indicative of a request for the aperiodic CSI report; and transmit, in response to the request, the aperiodic CSI report, wherein the aperiodic CSI report includes the measurement information.

In another example, a method for wireless communication is provided, the method including: receiving a first message associated with an aperiodic channel state information (CSI) report, wherein the first message indicates a request for the aperiodic CSI report is scheduled; generating, based on a measurement configuration indicated by the first message, measurement information for the aperiodic CSI report; receiving a second message indicative of a request for the aperiodic CSI report; and transmitting, in response to the request, the aperiodic CSI report, wherein the aperiodic CSI report includes the measurement information.

In another example, a non-transitory computer-readable storage medium is provided comprising instructions stored thereon which, when executed by at least one processor, causes the at least one processor to: receive a first message associated with an aperiodic channel state information (CSI) report, wherein the first message indicates a request for the aperiodic CSI report is scheduled; generate, based on a measurement configuration indicated by the first message, measurement information for the aperiodic CSI report; receive a second message indicative of a request for the aperiodic CSI report; and transmit, in response to the request, the aperiodic CSI report, wherein the aperiodic CSI report includes the measurement information.

In another example, an apparatus is provided for wireless communication. The apparatus includes: means for receiving a first message associated with an aperiodic channel state information (CSI) report, wherein the first message indicates a request for the aperiodic CSI report is scheduled; means for generating, based on a measurement configuration indicated by the first message, measurement information for the aperiodic CSI report; means for receiving a second message indicative of a request for the aperiodic CSI report; and means for transmitting, in response to the request, the aperiodic CSI report, wherein the aperiodic CSI report includes the measurement information.

Aspects generally include a method, apparatus, system, computer program product, non-transitory computer-readable medium, user equipment, base station, wireless communication device, and/or processing system as substantially described herein with reference to and as illustrated by the drawings and specification. The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim. The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment (UE), in accordance with some examples;

FIG. 5 is a diagram illustrating an example of physical channels and reference signals in a wireless network, in accordance with some examples;

FIGS. 6A-6C illustrate examples of downlink control information (DCI) scheduling of a physical uplink shared channel (PUSCH) transmission, in accordance with some examples;

FIG. 7 is a diagram illustrating an example of a media access control (MAC)-control element (CE) (MAC-CE) associated with aperiodic channel state information (CSI) state subselection, in accordance with some examples;

FIG. 8 is a diagram illustrating an example of an early indication message corresponding to at least one of an uplink (UL) DCI for an aperiodic CSI report and a PUSCH aperiodic CSI report transmission, in accordance with some examples;

FIG. 9A is a diagram illustrating a first example of a mapping between aperiodic CSI trigger states and respective trigger state indices, in accordance with some examples;

FIG. 9B is a diagram illustrating a second example of a mapping between aperiodic CSI trigger states and a respective trigger state index, in accordance with some examples;

FIG. 10 is a flow diagram illustrating an example of a process for wireless communication, in accordance with some examples; and

FIG. 11 is a block diagram illustrating an example of a computing system, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Wireless communication networks can be deployed to provide various communication services, such as voice, video, packet data, messaging, broadcast, any combination thereof, or other communication services. A wireless communication network may support both access links and sidelinks for communication between wireless devices. An access link may refer to any communication link between a client device (e.g., a user equipment (UE), a station (STA), or other client device) and a base station (e.g., a 3GPP gNB for 5G/NR, a 3GPP eNB for 4G/LTE, a Wi-Fi access point (AP), or other base station). For example, an access link may support uplink signaling, downlink signaling, connection procedures, etc. An example of an access link is a Uu link or interface (also referred to as an NR-Uu) between a 3GPP gNB and a UE.

A wireless communication network may perform resource allocation for time domain resources, and may perform resource allocation for frequency domain resources. The collective resource allocation process may also be referred as the allocation of time-frequency resources. Resource allocation in the time domain can be performed to indicate one or more time domain resources (e.g., time slots) that are configured or available for transmission. For example, uplink or downlink transmissions may be performed during the time slot(s) indicated by a time domain resource allocation, and should not be performed outside of the time slot(s) indicated by the time domain resource allocation. Resource allocation in the frequency domain can be performed to indicate one or more frequency domain resources (e.g., subcarriers, tones, etc.) that are configured or available for transmission. For example, uplink or downlink transmissions may be performed using the frequency subcarriers or tones indicated by the frequency domain resource allocation, and should not be performed using frequencies of subcarriers or tones outside of the frequency domain resource allocation.

One or more parameters can be signaled and/or configured by the network for use in time domain resource allocation. For example, a network entity (e.g., base station, gNB, etc.) can use a K₀ parameter to indicate the number of time slots between a physical downlink control channel (PDCCH) downlink control information (DCI) and a subsequent downlink data transmission (e.g., physical downlink shared channel (PDSCH)). A K₁ parameter can be indicative of the number of time slots between PDSCH and hybrid automatic repeat request (HARQ) acknowledge (ACK)/negative acknowledgement (NACK) transmission. A K₂ parameter can be indicative of the number of time slots between a PDDCH DCI and an uplink data (e.g., physical uplink shared channel (PUSCH)) transmission scheduled by the DCI.

In some cases, the parameters K₀, K₁, and K₂ can be referred to as timing offsets and/or timing offset parameters and/or network timing offsets. For example, the timing offset parameters may be used to indicate a time delay (e.g., in number of time slots) between different types of transmissions. For example, the K₀ parameter can indicate the time delay between a DCI slot and a PDSCH slot. For example, a UE may receive a DCI at t_{DCI} and can use the K₀ parameter to determine the time of the next downlink data transmission as the PDSCH slot t_{PDSCH}=t_{DCI}+K₀.

In another example, the K₁ parameter can indicate the time delay between a PDSCH transmission and the reception of the physical uplink control channel (PUCCH) that carries an ACK or NACK for the PDSCH. For example, the K₁ parameter can be used to indicate the time delay between a PDSCH slot and an uplink control information (UCI) slot for HARQ ACK/NACK. In some cases, a UE may receive a PDSCH transmission and can use the K₁ parameter to determine timing information for the later transmission of HARQ ACK/NACK feedback indicating that the UE successfully received (e.g., HARQ ACK) or did not successfully receive (e.g., HARQ NACK) the PDSCH data transmission. For a PDSCH transmission scheduled for time slot t_{PDSCH}, the UE can be configured to transmit the corresponding HARQ ACK or NACK feedback for the PDSCH at the time slot calculated as t_{HARQ}=I_{DCI}+K₁.

In another example, the K₂ parameter can indicate the time delay between a PDDCH with a scheduling DCI (e.g., a DCI scheduling a future uplink transmission by the UE), and the corresponding uplink transmission scheduled by the DCI (e.g., a PUSCH transmission). For example, a UE may receive a scheduling DCI at time slot t_{DCI} and can be configured to transmit the corresponding uplink transmission (e.g., PUSCH) after a time delay of at least K₂ slots. In some cases, the UE can determine the transmission time for the uplink transmission scheduled by the DCI based on t_{UL}=t_{DCI}+K₂.

The value of the K₂ parameter may directly impact the processing time available to a UE for preparing uplink transmissions in response to receiving a scheduling DCI. For example, lower values of K₂ correspond to shorter processing times available to the UE before the corresponding uplink transmission is sent in response to the scheduling DCI. Larger values of K₂ correspond to longer processing times available to the UE before sending the corresponding uplink transmission in response to the scheduling DCI.

In some cases, the K₂ timing offset parameter can be used to determine the slot timing for an aperiodic channel state information (CSI) report without a transport block. For example, the value of K₂ may be determined to be the maximum slot offset value Yⱼ across all N_{Rep} aperiodic CSI reports (j=0, . . . , N_{Rep}−1) associated with a signaled aperiodic CSI trigger state. In some cases, the signaled aperiodic CSI trigger state may correspond to a network entity (e.g., base station, gNB, etc.) that uses different K₂ slot offset values for different PUSCH configurations (e.g., different PUSCH scenarios and/or use cases, etc.). For example, a network entity may use a first K₂ slot offset value for PUSCH data without or without CSI. The network entity may use a second K₂ slot offset value for PUSCH aperiodic CSI without data.

Performing aperiodic CSI reporting with multiple values of the K₂ timing offset parameter can increase the complexity associated with uplink scheduling and/or associated with an uplink transmission timeline for a UE. For example, the complexity of uplink scheduling and the UE uplink timeline may increase when two different K₂ slot offset values are configured from the UL DCI transmission or UL scheduling decision to the PUSCH reception. There is a need for systems and techniques that can be used for aperiodic CSI reporting and PUSCH scheduling using a single slot offset value for both PUSCH data with or without CSI, and for PUSCH aperiodic CSI without data.

Systems, apparatuses, processes (also referred to as methods), and computer-readable media (collectively referred to as “systems and techniques”) are described herein that can be used to configure aperiodic CSI reporting to use one slot offset value for PUSCH data with or without CSI, and for PUSCH aperiodic CSI without data. In some examples, the systems and techniques can provide a UE with additional processing time for generating an aperiodic CSI report based on transmitting an early indication for an upcoming aperiodic CSI report request. For example, a network entity can transmit to a UE an indication that a CSI report request will be transmitted in a future (e.g., upcoming) time slot. Based on receiving the early indication of the aperiodic CSI report, the UE can begin performing one or more measurements and/or can prepare for performing one or more measurements corresponding to the upcoming aperiodic CSI report. For example, the UE may receive the early indication of the upcoming CSI report request, and can measure and/or prepare for channel and/or interference measurement of one or more CSI-reference signal (CSI-RS) and/or CSI-interference measurement (CSI-IM) resources.

In some cases, a network entity can transmit (and a UE can receive) a first message associated with an aperiodic CSI report. The first message can be an early indication of an upcoming CSI report request. For example, the first message can indicate a request for the aperiodic CSI report is scheduled. The request for the aperiodic CSI report may be scheduled for a time slot that is later than the time slot associated with the first message (e.g., the time slot the network entity transmits the early indication using the first message, and/or the time slot the UE receives the early indication first message from the network entity, etc.). In some cases, the first message can indicate the request for the aperiodic CSI report is scheduled, without indicating a particular future time slot for which the aperiodic CSI report will be transmitted. In some examples, the first message can indicate the request for the aperiodic CSI report is scheduled and may include an additional indication of the particular future time slot for which the aperiodic CSI report is scheduled to be transmitted by the network entity.

In some examples, a UE can receive the first message with the early indication corresponding to the upcoming request for the aperiodic CSI report. Based on the early indication of the first message, the UE can be configured to generate measurement information for the aperiodic CSI report. For example, the measurement information can include and/or can be generated based on one or more channel measurements performed by the UE. In some cases, the measurement information can include respective values (e.g., measured values, etc.) for at least a portion of the one or more channel measurements. In some examples, the measurement information can include values and/or information that are derived from and/or generated based on the one or more channel measurements, without the measurement information including the channel measurement values directly. In some cases, the measurement information can be obtained and/or generated by the UE as a payload for inclusion in a CSI report. The measurement information can be associated with, based on, indicative of, and/or can comprise measurements of one or more measurement resources. The measurement resources can include one or more of CSI-RS measurement resources, CSI-IM measurement resources, and/or SSB measurement resources, etc.

In some cases, to generate the measurement information, the UE can be configured to obtain and/or determine the one or more channel measurements. For example, the one or more channel measurements used to generate the measurement information can be obtained based on a measurement configuration indicated by the first message. In some cases, the measurement information can be generated based on one or more channel measurements that include at least one CSI-RS measurement of one or more CSI-RS resources according to the measurement configuration, and/or that include at least one CSI-IM measurement of one or more CSI-IM resources according to the measurement configuration. In some cases, the measurement information can be generated based on and/or using one or more channel measurements that include at least one synchronization signal block (SSB) measurement according to the measurement configuration.

The network entity can transmit (and the UE can receive) a second message indicative of a request for the aperiodic CSI report. The second message can be an uplink (UL) downlink control information (DCI) (UL DCI) indicative of the request for the aperiodic CSI report. The UL DCI can be received by the UE after (e.g., at a later time slot) than the first message with the early indication of the upcoming request for an aperiodic CSI report. In some examples, to receive the second message, the UE decodes the UL DCI to determine the request for the aperiodic CSI report. In some cases, the UE is configured to obtain one or more channel measurements and generate the measurement information using the one or more channel measurements. The UE may be configured to obtain the channel measurements and generate the measurement information in response to the early indication of the first message, before the UE decodes the UL DCI. For example, the first message (e.g., indicative of the early indication of the upcoming request for the aperiodic CSI report) can be associated with a first transmission time. The upcoming request for the aperiodic CSI report, indicated by the first message, can be the same as the request for the aperiodic CSI report determined by the UE from the second message. For example, the upcoming request for the aperiodic CSI report and the second message can both be associated with a second transmission time that is later than the first time corresponding to the early indication of the first message.

In some cases, the network entity can transmit (and the UE can receive) a radio resource control (RRC) message to enable the early indication configuration for aperiodic CSI reporting. For example, the RRC message indicative of enablement of the early indication configuration can configure the UE to receive and decode the first message indicative of the early indication. An RRC message that is not indicative of the enablement of the early indication configuration can cause the UE to skip or ignore the time slot(s) where the network entity transmits the first message with the early indication. In some cases, the early indication can be included in a first message comprising an uplink (UL) DCI including an early indication field equal to a first value. The first value can correspond to an UL DCI configuration for early indication of the request for the aperiodic CSI report. In some examples, the second message can be an UL DCI including the early indication field equal to a second value. The second value can correspond to an UL DCI configuration for the request for the aperiodic CSI report. For example, an UL DCI with the first value can correspond to the early indication of the request to the UE, and an UL DCI with the second value can correspond to the request for the aperiodic CSI report.

Further aspects of the systems and techniques will be described with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), aircraft (e.g., an airplane, jet, unmanned aerial vehicle (UAV) or drone, helicopter, airship, glider, etc.), and/or Internet of Things (IOT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.), and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (e.g., a network of spatially separated antennas connected to a common source via a transport medium) or a remote radio head (RRH) (e.g., a remote base station connected to a serving base station). Alternatively, the non-co-located physical TRPs may be the serving base station receiving the measurement report from the UE and a neighbor base station whose reference radio frequency (RF) signals (e.g., or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, a processing system, an integrated access and backhauling (IAB) node, a distributed unit (DU), a central unit (CU), a remote unit (RU), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, processing system, or the like may include disclosure of the UE, base station, apparatus, device, computing system, processing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first processing system, a first one or more components, a first processing entity, or the like configured to receive the information; and the second network node may refer to a second UE, a second base station, a second apparatus, a second device, a second computing system, a second processing system, a second one or more components, a second processing entity, or the like.

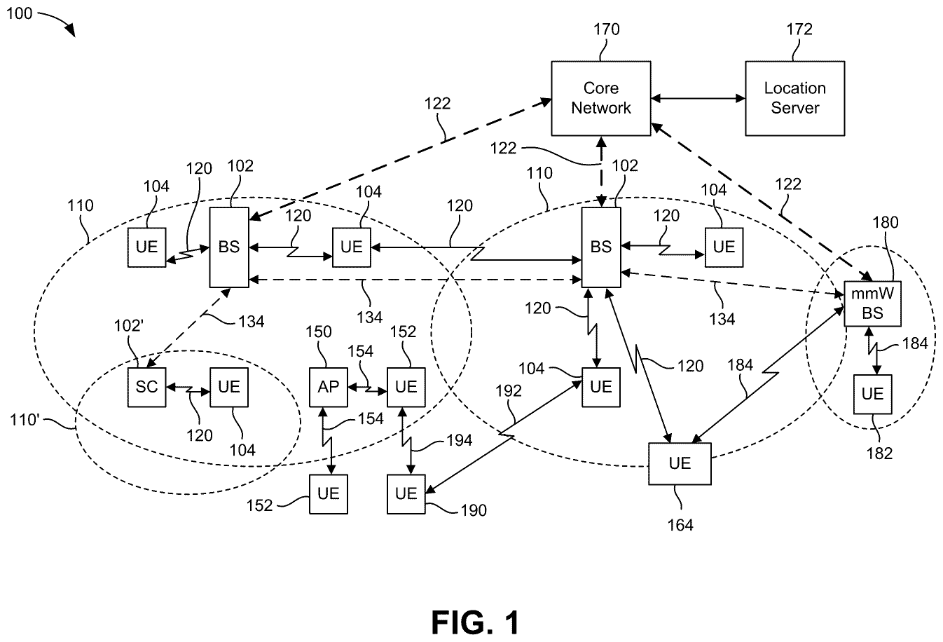

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IOT) device, an energy harvesting (EH)-capable device, a network controller, an apparatus, a device, a computing system, a processing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network 100 of FIG. 1. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, network node, apparatus, device, computing system, processing system or the like may include disclosure of the UE, base station, network node, apparatus, device, computing system, processing system or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first processing system, a first set of one or more one or more components, a first processing entity, or the like configured to receive the information; and the second network entity may refer to a second UE, a second base station, a second apparatus, a second device, a second computing system, a second processing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

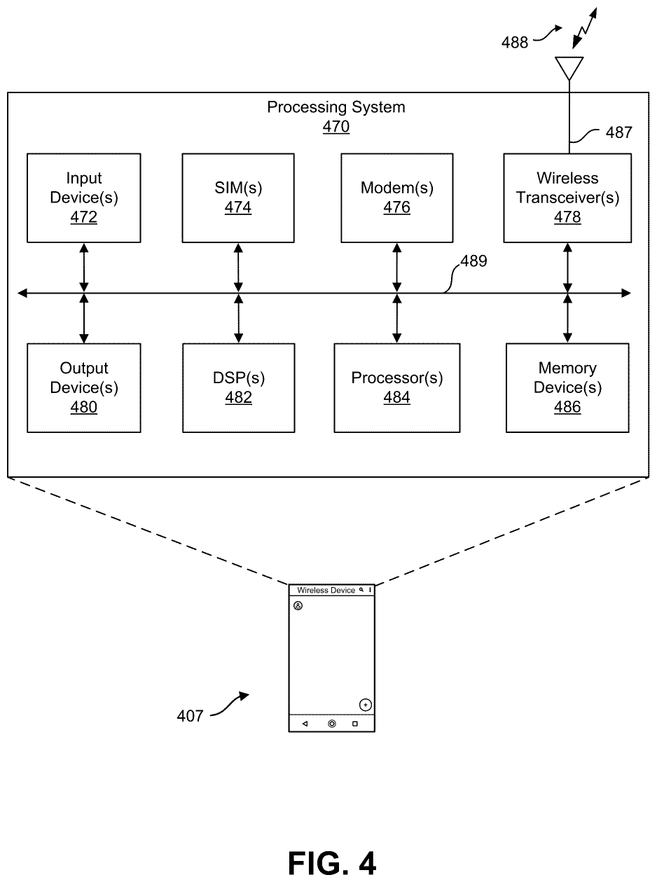

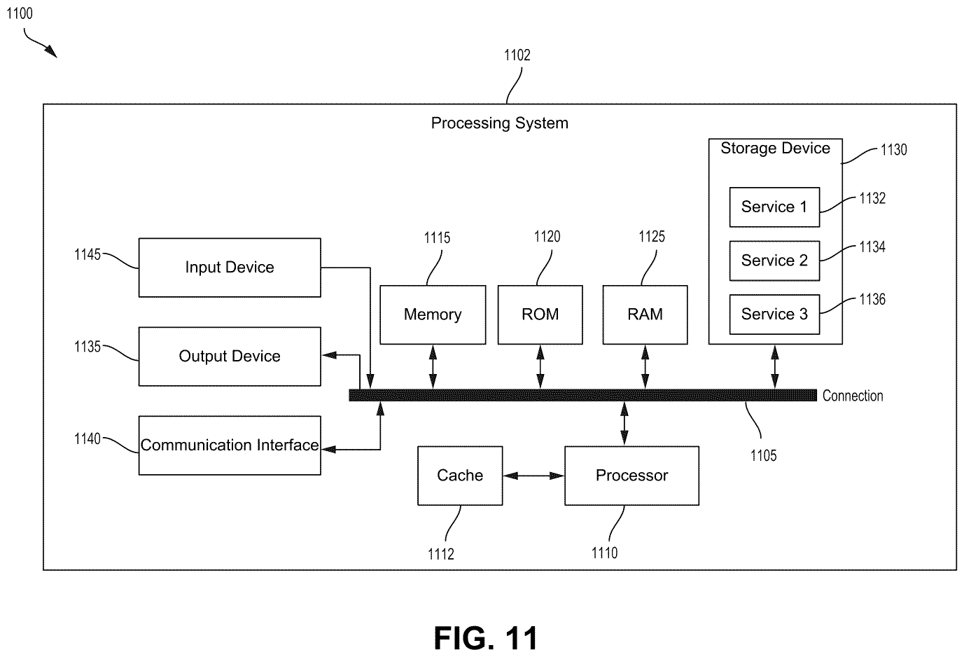

In some examples, the network entity 102 may include a processing system (e.g., such as the processing system 470 of FIG. 4 and/or the processing system 1102 of FIG. 11, etc.). Similarly, the network entity 180 (e.g., a millimeter wave (mmW) base station, etc.) may include a respective processing system (e.g., such as the processing system 470 of FIG. 4 and/or the processing system 1102 of FIG. 11, etc.). A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

Various aspects of the systems and techniques described herein will be discussed below with respect to the figures. According to various aspects, FIG. 1 illustrates an example of a wireless communications system 100. The wireless communications system 100 (e.g., which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally, or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (e.g., high power cellular base stations) and/or small cell base stations (e.g., low power cellular base stations). In an aspect, the macro cell base station may include eNBs and/or ng-eNBs where the wireless communications system 100 corresponds to a long-term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IOT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (e.g., also referred to as reverse link) transmissions from a UE 104 to a base station 102 and/or downlink (e.g., also referred to as forward link) transmissions from a base station 102 to a UE 104. The communication links 120 may use MIMO antenna technology, including spatial multiplexing, beamforming, and/or transmit diversity. The communication links 120 may be provided using one or more carrier frequencies. Allocation of carriers may be asymmetric with respect to downlink and uplink (e.g., a greater or lesser quantity of carriers may be allocated for downlink than for uplink).

Beamforming, which may also be referred to as spatial filtering, directional transmission, or directional reception, is a signal processing technique that may be used at a transmitting device or a receiving device (e.g., one or more of the base stations 102, UEs 104, etc.) to shape or steer an antenna beam (e.g., a transmit beam, a receive beam) along a spatial path between the transmitting device and the receiving device. Beamforming may be implemented based on combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A transmitting device and/or a receiving device (e.g., such as one or more of base stations 102 and/or UEs 104) may use beam sweeping techniques as part of beam forming operations. For example, a base station 102 (e.g., or other transmitting device) may use multiple antennas or antenna arrays (e.g., antenna panels) to conduct beamforming operations for directional communications with a UE 104 (e.g., or other receiving device). Some signals (e.g., synchronization signals, reference signals, beam selection signals, or other control signals) may be transmitted by base station 102 (or other transmitting device) multiple times in different directions. For example, the base station 102 may transmit a signal according to different beamforming weight sets associated with different directions of transmission. Transmissions in different beam directions may be used to identify (e.g., by a transmitting device, such as a base station 102, or by a receiving device, such as a UE 104) a beam direction for later transmission or reception by the base station 102.

Some signals, such as data signals associated with a particular receiving device, may be transmitted by a base station 102 in a single beam direction (e.g., a direction associated with the receiving device, such as a UE 104). In some examples, the beam direction associated with transmissions along a single beam direction may be determined based on a signal that was transmitted in one or more beam directions. For example, a UE 104 may receive one or more of the signals transmitted by the base station 102 in different directions and may report to the base station 102 an indication of the signal that the UE 104 received with a highest signal quality or an otherwise acceptable signal quality.

In some examples, transmissions by a device (e.g., by a base station 102 or a UE 104) may be performed using multiple beam directions, and the device may use a combination of digital precoding or radio frequency beamforming to generate a combined beam for transmission (e.g., from a base station 102 to a UE 104, from a transmitting device to a receiving device, etc.). The UE 104 may report feedback that indicates precoding weights for one or more beam directions, and the feedback may correspond to a configured number of beams across a system bandwidth or one or more sub-bands. The base station 102 may transmit a reference signal (e.g., a cell-specific reference signal (CRS), a channel state information reference signal (CSI-RS), etc.), which may be precoded or unprecoded. The UE 104 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 102, a UE 104 may employ similar techniques for transmitting signals multiple times in different directions (e.g., for identifying a beam direction for subsequent transmission or reception by the UE 104) or for transmitting a signal in a single direction (e.g., for transmitting data to a receiving device).

A receiving device (e.g., a UE 104) may try multiple receive configurations (e.g., directional listening) when receiving various signals from the base station 102, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc., utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (e.g., transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (e.g., from 450 to 6,000 Megahertz (MHz)), FR2 (e.g., from 24,250 to 52,600 MHZ), FR3 (e.g., above 52,600 MHz), and FR4 (e.g., between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (e.g., whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (e.g., x component carriers) for transmission in each direction.

The component carriers may or may not be adjacent to each other on the frequency spectrum. Allocation of carriers may be asymmetric with respect to the downlink and uplink (e.g., a greater or lesser quantity of carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (e.g., 40 MHz), compared to that attained by a single 20 MHz carrier.

In order to operate on multiple carrier frequencies, a base station 102 and/or a UE 104 can be equipped with multiple receivers and/or transmitters. For example, a UE 104 may have two receivers, “Receiver 1” and “Receiver 2,” where “Receiver 1” is a multi-band receiver that can be tuned to band (e.g., carrier frequency) ‘X’ or band ‘Y,’ and “Receiver 2” is a one-band receiver tunable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (e.g., an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (e.g., referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (e.g., through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

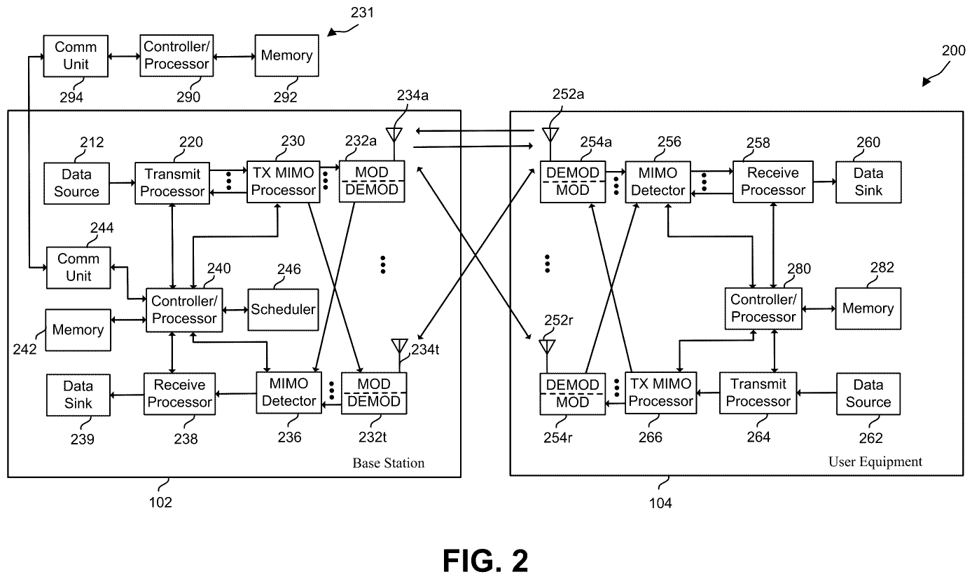

FIG. 2 illustrates a block diagram of an example architecture 200 of a base station 102 and a UE 104 that enables transmission and processing of signals exchanged between the UE and the base station, in accordance with some aspects of the present disclosure. Example architecture 200 includes components of a base station 102 and a UE 104, which may be one of the base stations 102 and one of the UEs 104 illustrated in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based on channel quality indicators (CQIs) received from the UE, process (e.g., encode and modulate) the data for each UE based on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators can be separate components. Each modulator of the modulators 232a to 232t may process a respective output symbol stream (e.g., for an orthogonal frequency-division multiplexing (OFDM) scheme and/or the like) to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals can be generated with location encoding to convey additional information.

At UE 104, antennas 252a through 252r may receive the downlink signals from base station 102 and/or other base stations and may provide received signals to one or more demodulators (DEMODs) 254a through 254r, respectively. The demodulators 254a through 254r are shown as a combined modulator-demodulator (MOD-DEMOD). In some cases, the modulators and demodulators can be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based on a beta value or a set of beta values associated with the one or more reference signals). The symbols from transmit processor 264 may be precoded by a TX-MIMO processor 266, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 (e.g., if applicable), and further processed by a receive processor 238 to obtain decoded data and control information sent by UE 104. Receive processor 238 may provide the decoded data to a data sink 239 and the decoded control information to controller (e.g., processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (e.g., such as a Node B (NB), evolved NB (eNB), NR BS, 5G NB, access point (AP), a transmit receive point (TRP), or a cell, etc.) may be implemented as an aggregated base station (e.g., also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (e.g., such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations May be utilized in an integrated access backhaul (IAB) network, an open radio access network (O-RAN (e.g., such as the network configuration sponsored by the O-RAN Alliance)), or a virtualized radio access network (e.g., vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

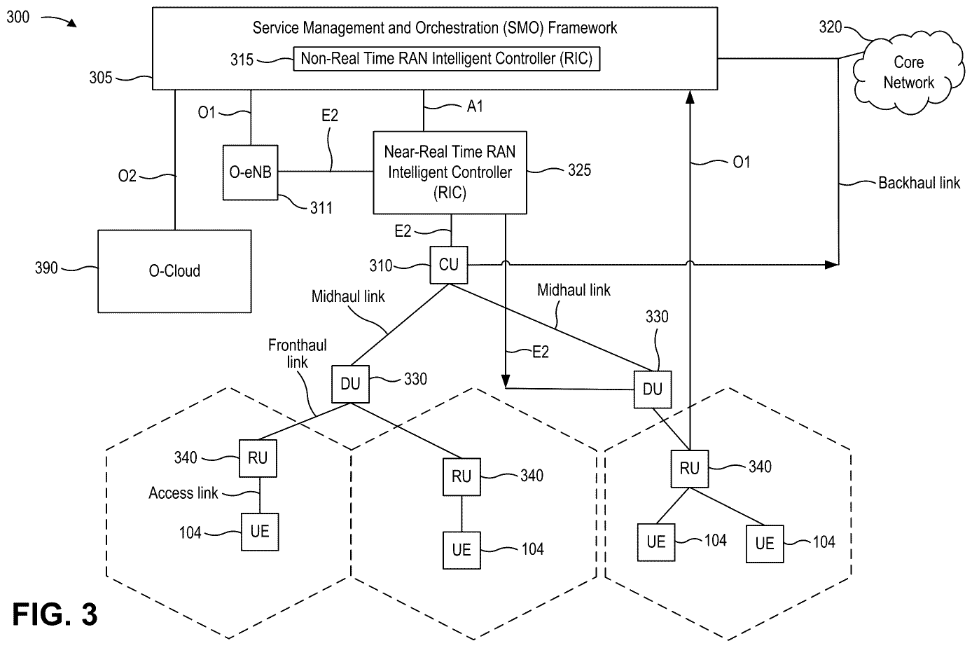

FIG. 3 is a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (e.g., such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUS) 340 via respective fronthaul links. The RUs 340 may communicate with respective UEs 104 via one or more radio frequency (RF) access links. In some implementations, the UE 104 may be simultaneously served by multiple RUs 340.

Each of the units (e.g., the CUS 310, the DUs 330, the RUs 340, as well as the Near-RT RICs 325, the Non-RT RICs 315, and the SMO Framework 305) illustrated in FIG. 3 and/or described herein may include one or more interfaces or be coupled to one or more interfaces configured to receive or transmit signals, data, or information (e.g., collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (e.g., such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (e.g., such as modules for forward error correction (FEC) encoding and decoding, scrambling, modulation and demodulation, or the like) depending on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (e.g., such as performing fast Fourier transform (FFT), inverse FFT (iFFT), digital beamforming, physical random-access channel (PRACH) extraction and filtering, or the like), or both, based on the functional split, such as a lower layer functional split. In such an architecture, the RU(s) 340 can be implemented to handle over the air (OTA) communication with one or more UEs 104. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (e.g., such as an O1 interface). For virtualized network elements, the SMO Framework 305 may be configured to interact with a cloud computing platform (e.g., such as an open cloud (O-Cloud) 390) to perform network element life cycle management (e.g., such as to instantiate virtualized network elements) via a cloud computing platform interface (e.g., such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (e.g., such as via an A1 interface) the Near-RT RIC 325. The Near-RT RIC 325 may be configured to include a logical function that enables near-real-time control and optimization of RAN elements and resources via data collection and actions over an interface (e.g., such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (e.g., such as reconfiguration via 01) or via creation of RAN management policies (e.g., such as A1 policies).

FIG. 4 illustrates an example of a processing system 470 of a wireless device 407. In some examples, the processing system 470 may also be referred to as a computing system. The processing system 470 may include and/or implement one or more components that are the same as or similar to respective components included in and/or implemented by the processing system 1102 of FIG. 11 (e.g., and the processing system 1102 of FIG. 11 may include and/or implement one or more components that are the same as or similar to respective components included in and/or implemented by the processing system 470 of FIG. 4). In some cases, the wireless device 407 may also be referred to as a user computing device. The wireless device 407 may include a client device such as a UE (e.g., UE 104, UE 152, UE 190) or other type of device (e.g., a station (STA) configured to communication using a Wi-Fi interface) that may be used by an end-user. In some cases, the processing system 470 of the wireless device 407 can be implemented by one or more of the UEs 104 of FIG. 1. For example, the wireless device 407 may include a mobile phone, router, tablet computer, laptop computer, tracking device, wearable device (e.g., a smart watch, glasses, an extended reality (XR) device such as a virtual reality (VR), augmented reality (AR), or mixed reality (MR) device, etc.), Internet of Things (IOT) device, a vehicle, an aircraft, and/or another device that is configured to communicate over a wireless communications network.

The processing system 470 includes software and hardware components that may be electrically or communicatively coupled via a bus 489 (e.g., or may otherwise be in communication, as appropriate). The processing system 470 may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. For example, the processing system 470 includes one or more processors 484. The one or more processors 484 may include one or more CPUs, ASICs, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The processing system 470 may also include one or more memory devices 486, one or more digital signal processors (DSPs) 482, one or more SIMs 474, one or more modems 476, one or more wireless transceivers 478, an antenna 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, processing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the processing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (e.g., also referred to as a signal multiplier) for signal down conversion, a frequency synthesizer (e.g., also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the processing system 470 may include a coding-decoding device (or CODEC) configured to encode and/or decode data transmitted and/or received using the one or more wireless transceivers 478. In some cases, the processing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The processing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable, and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 486 and executed by the one or more processor(s) 484 and/or the one or more DSPs 482. The processing system 470 may also include software elements (e.g., located within the one or more memory devices 486), including, for example, an operating system, device drivers, executable libraries, and/or other code, such as one or more application programs, which may comprise computer programs implementing the functions provided by various aspects, and/or may be designed to implement methods and/or configure systems, as described herein.

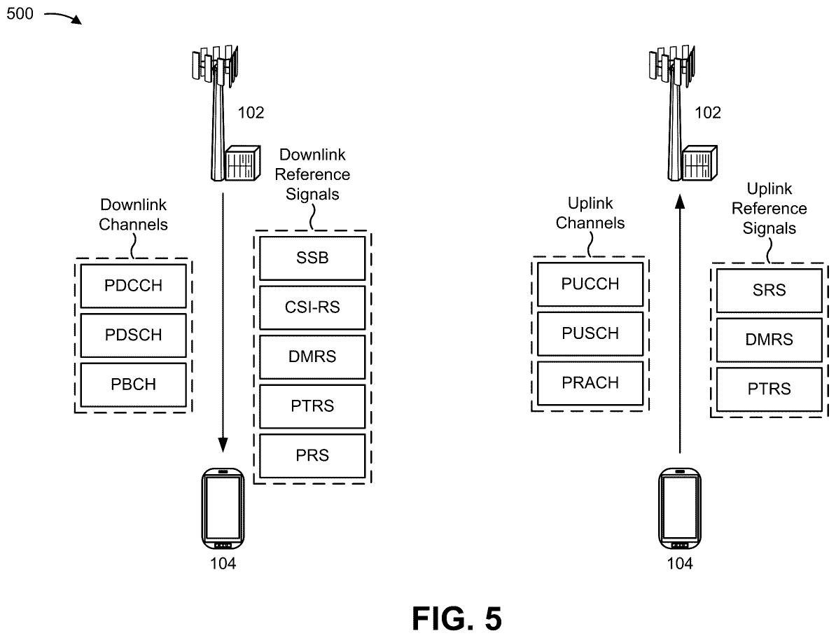

FIG. 5 is a diagram illustrating an example 500 of physical channels and reference signals in a wireless network. In some examples, one or more downlink channels and one or more downlink reference signals may carry information from a base station 102 to a UE 104. One or more uplink channels and one or more uplink reference signals may carry information from UE 104 to base station 102.

In some aspects, a downlink channel may include one or more of a physical downlink control channel (PDCCH) that carries downlink control information (DCI), a physical downlink shared channel (PDSCH) that carries downlink data, and/or a physical broadcast channel (PBCH) that carries system information, among other examples. In some aspects, PDSCH communications may be scheduled by PDCCH communications.

In some examples, an uplink channel may include one or more of a physical uplink control channel (PUCCH) that carries uplink control information (UCI), a physical uplink shared channel (PUSCH) that carries uplink data, and/or a physical random access channel (PRACH) used for initial network access, among other examples. In some aspects, UE 104 may transmit acknowledgement (ACK) or negative acknowledgement (NACK) feedback (e.g., ACK/NACK feedback or ACK/NACK information) in UCI on the PUCCH and/or the PUSCH.

In some cases, a downlink reference signal may include one or more of a synchronization signal block (SSB), a channel state information (CSI) reference signal (CSI-RS), a demodulation reference signal (DMRS), a positioning reference signal (PRS), and/or a phase tracking reference signal (PTRS), among other examples. In some examples, an uplink reference signal may include one or more of a sounding reference signal (SRS), a DMRS, and/or a PTRS, among other examples.

An SSB may carry or include information used for initial network acquisition and synchronization. For example, an SSB can carry or include one or more of a primary synchronization signal (PSS), a secondary synchronization signal (SSS), a PBCH, and/or a PBCH DMRS. An SSB may also be referred to as a synchronization signal/PBCH (SS/PBCH) block. In some aspects, base station 102 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. For example, base station 102 can configure a set of CSI-RSs for UE 104, and UE 104 can measure the configured set of CSI-RSs. Based on the CSI-RS measurements, UE 104 can perform channel estimation and report channel estimation parameters to base station 102 (e.g., in a CSI report). For example, the channel estimation parameters can include one or more of a channel quality indicator (CQI), a precoding matrix indicator (PMI), a CSI-RS resource indicator (CRI), a layer indicator (LI), a rank indicator (RI), and/or a reference signal received power (RSRP), among other examples.

In some examples, base station 102 can use the CSI report to select transmission parameters for downlink communications to UE 104. For example, base station 102 can use the CSI report to select transmission parameters that include one or more of a quantity of transmission layers (e.g., a rank), a precoding matrix (e.g., a precoder), a modulation and coding scheme (MCS), and/or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS can carry information used to compensate for oscillator phase noise. In some cases, oscillator phase noise may increase as an oscillator carrier frequency increases. In some examples, a PTRS can be utilized at high carrier frequencies (e.g., such as millimeter wave frequencies) to mitigate oscillator phase noise. The PTRS may be used to track the phase of the local oscillator and to enable suppression of phase noise and common phase error (CPE). As illustrated in FIG. 5, in some examples one or more PTRSs can be used for both downlink communications (e.g., on the PDSCH) and uplink communications (e.g., on the PUSCH).

A PRS may carry information associated with timing or ranging measurements of UE 104. For example, UE 104 may utilize one or more signals (e.g., PRSs) transmitted by base station 102 to improve an observed time difference of arrival (OTDOA) positioning performance. In some examples, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). A PRS can be designed to improve detectability by UE 104, which may need to detect downlink signals from multiple neighboring base stations in order to perform OTDOA-based positioning. Accordingly, UE 104 may receive a PRS from multiple cells (e.g., a reference cell and one or more neighbor cells), and may report a reference signal time difference (RSTD) based on OTDOA measurements associated with the PRSs received from the multiple cells. In some aspects, base station 102 can calculate a position of UE 104 based on the RSTD measurements reported by UE 104.

In some examples, an SRS can carry information used for uplink channel estimation, which may be used for scheduling, link adaptation, precoder selection, and/or beam management, among other examples. Base station 102 can configure one or more SRS resource sets for UE 104, and UE 104 can transmit SRSs on the configured SRS resource sets. An SRS resource set may have a configured usage, such as uplink CSI acquisition, downlink CSI acquisition for reciprocity-based operations, uplink beam management, among other examples. Base station 102 may measure the SRSs, may perform channel estimation based on the measurements, and/or may use the SRS measurements to configure communications with UE 104.

As noted above, systems and techniques are provided that can be used to configure early indication signaling indicative of an upcoming request for an aperiodic CSI report. For example, the systems and techniques can be used for early indication signaling between a network entity and a UE, where the early indication signaling is based on one or more messages from the network entity to the UE, indicating that a request for an aperiodic CSI report will be transmitted to the UE at a future time (e.g., future or upcoming time slot).

Timing offset parameters can be used by a network entity and a UE for determining time domain resource allocation, including for synchronization between the network entity and the UE of the particular time(s) and/or time slot(s) where various types of transmissions will be performed. For example, a network entity (e.g., base station, gNB, etc.) can use a K₀ parameter to indicate the number of time slots between a PDCCH DCI and a subsequent downlink data transmission (e.g., PDSCH). A K₁ parameter can be indicative of the number of time slots between PDSCH and HARQ ACK/NACK feedback transmissions. A K₂ parameter can be indicative of the number of time slots between a PDDCH DCI and an uplink data transmission (e.g., PUSCH) scheduled by the DCI.

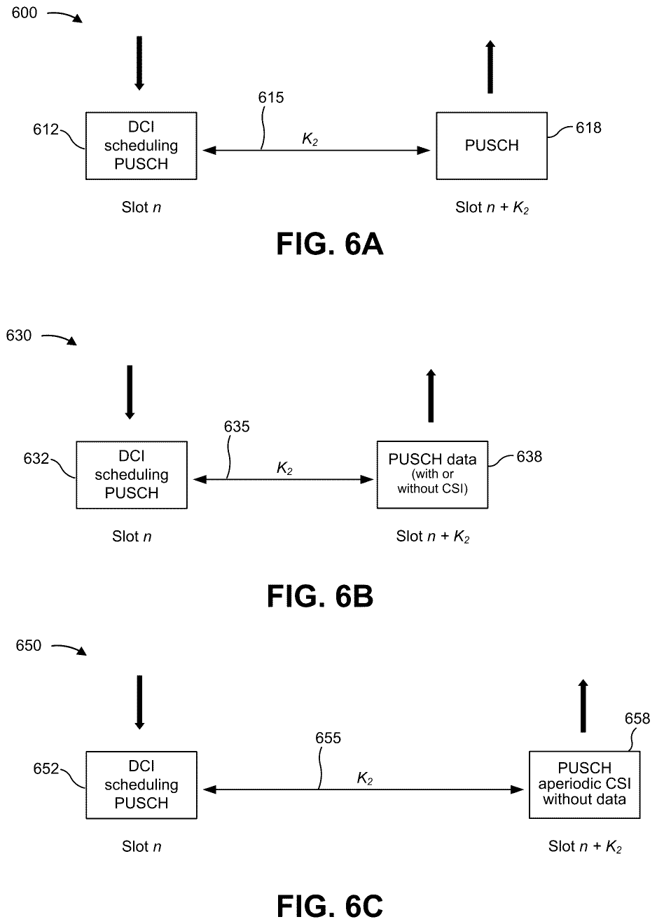

For example, FIGS. 6A-6C illustrate examples of the K₂ parameter that may be used for determining a time offset (e.g., delay) between a scheduling DCI and the corresponding PUSCH transmission scheduled by the DCI. FIG. 6A illustrates an example of a first K₂ timing offset configuration 600, where a DCI 612 scheduling a PUSCH is received by a UE in a first time slot n 612. Based on a configured value for the K₂ timing offset parameter, the UE can determine a timing offset (e.g., delay) 615 between the scheduling DCI 612 and the corresponding PUSCH transmission 618 scheduled by the DCI 612. The length of the timing offset 615 can be equal to the configured value of the K₂ timing offset parameter, and the transmission time of the PUSCH 618 can be determined as the later time slot determined as slot n+K₂.

As noted above, the value of the K₂ parameter may directly impact the processing time available to a UE for preparing uplink transmissions in response to receiving a scheduling DCI. For example, lower values of K₂ correspond to a shorter time offset (e.g., delay) 615 before the UE transmits the PUSCH 618, which corresponds to a shorter processing time available to the UE for preparing the uplink transmission data for the PUSCH 618 in response to the DCI 612. Larger values of K₂ correspond to a longer time offset (e.g., delay) 615 before the UE transmits the PUSCH 618, which corresponds to a longer processing time available to the UE for preparing the uplink transmission data for the PUSCH 618 in response to the scheduling DCI 612.

In some cases, a network entity (e.g., base station, gNB, etc.) may use different K₂ slot offset values for different PUSCH configurations (e.g., different PUSCH scenarios and/or use cases, etc.). For example, a network entity may use a first K₂ slot offset value for PUSCH data without or without CSI, corresponding to the example K₂ timing offset configuration 630 of FIG. 6B. The network entity may use a second K₂ slot offset value for PUSCH aperiodic CSI without data, corresponding to the example K₂ timing offset configuration 650 of FIG. 6C.

For example, the first K₂ slot offset 635 of FIG. 6B can be shorter (e.g., smaller, less than, etc.) the second K₂ slot offset 655 of FIG. 6C. The difference in K₂ values can correspond to a difference in processing time for the UE to prepare for transmitting the PUSCH data 638, with or without CSI, in response to the DCI scheduling PUSCH 632 received at slot n of FIG. 6B, and the relatively longer processing time that may be needed for the UE to prepare for transmitting the PUSCH aperiodic CSI 658 in response to the DCI scheduling PUSCH 652 received at slot n of FIG. 6C. In some cases, different K₂ slot offset values can be implemented and used to adjust the time delay or processing time available to the UE for preparing a corresponding PUSCH uplink transmission in response to receiving different types of scheduling DCIs. For example, the DCI 652 of FIG. 6C can correspond to an example where the DCI 652 is indicative of a request for the aperiodic CSI report of the PUSCH 658.

In some cases, the network entity and UE can be configured to determine the value (e.g., length) of the slot offset K₂ determined for the aperiodic CSI report without a transport block (e.g., PUSCH aperiodic CSI without data). For example, the value of K₂ used for PUSCH aperiodic CSI without data may correspond to the example configuration 650 of FIG. 6C and the K₂ offset 655 before the PUSCH aperiodic CSI without data 658. In some examples, the value of K₂ for a PUSCH aperiodic CSI without data (e.g., PUSCH 658) can be determined to be the maximum slot offset value Yⱼ across all N_{Rep} aperiodic CSI reports (j=0, . . . , N_{Rep}−1) associated with a signaled aperiodic CSI trigger state. For example, when a UE is scheduled to transmit a PUSCH with no transport block and with a CSI report by a CSI request field on a DCI, a Time domain resource assignment field value m of the DCI can be configured to provide a row index m+1 to an allocation table configured for the network (e.g., an allocation table known and/or available to the UE and the network entity). The indexed row can be indicative of a start and length indicator SLIV, or may directly indicate the start symbol S and the allocation length L, and the PUSCH mapping type to be applied in the PUSCH transmission, with the K₂ value determined as K₂=max Yⱼ (m+1), where Yⱼ, j=0, . . . , N_{Rep}−1 are the corresponding list entries of a corresponding higher layer parameter.

For example, for PUSCH data with or without CSI (e.g., such as the PUSCH 638 of FIG. 6B), the corresponding list entries for determining the K₂ value can be obtained from the higher layer parameter pusch-TimeDomainAllocationList in PUSCH-Config.

In another example, for PUSCH aperiodic CSI without data (e.g., such as PUSCH 658 of FIG. 6C), the corresponding list entries for determining the K₂ value can be from the higher layer parameter reportSlotOffsetList in CSI-ReportConfig for the N_{Rep} triggered CSI Reporting Settings, and where Yⱼ (m+1) represents the (m+1)th entry of Yⱼ. In some cases, the reportSlotOffsetList information can be included in a radio resource control (RRC) CSI-ReportConfig information element (IE) configured for the network entity and the UE. In some cases, the UE can obtain and/or determine the reportSlotOffsetList based on receiving from the network entity an RRC message for the CSI-ReportConfig 1E. In some cases, a corresponding reportSlotOffsetList can be included and/or signaled within the RRC message for the CSI-ReportConfig 1E based on the DCI format. For example, a reportSlotOffsetListDCI-0-2 can be used when the PUSCH 658 is scheduled by the DCI 652 with DCI format 0 2, where reportSlotOffsetListDCI-0-2 is configured as SEQUENCE (SIZE(1 . . . maxNrofUL-Allocations-r16)) OF INTEGER(0 . . . 32) for Release 16 and is configured as SEQUENCE(SIZE(1 . . . maxNrofUL-Allocations-r16)) OF INTEGER(0 . . . 128) for Release 17. In another example, a reportSlotOffsetListDCI-0-1 can be used when the PUSCH 658 is scheduled by the DCI 652 with DCI format 0 1, where reportSlotOffsetListDCI-0-2 is configured as SEQUENCE (SIZE(1 . . . maxNrofUL-Allocations-r16)) OF INTEGER (0 . . . 32) for Release 16 and is configured as SEQUENCE (SIZE(1 . . . maxNrofUL-Allocations-r16)) OF INTEGER(0 . . . 128) for Release 17. In some cases, the reportSlotOffsetList can be configured without dependency on the DCI format, for example as aperiodic reportSlotOffsetList given as SEQUENCE (SIZE(1 . . . maxNrofUL-Allocations)) OF INTEGER(0 . . . 32).

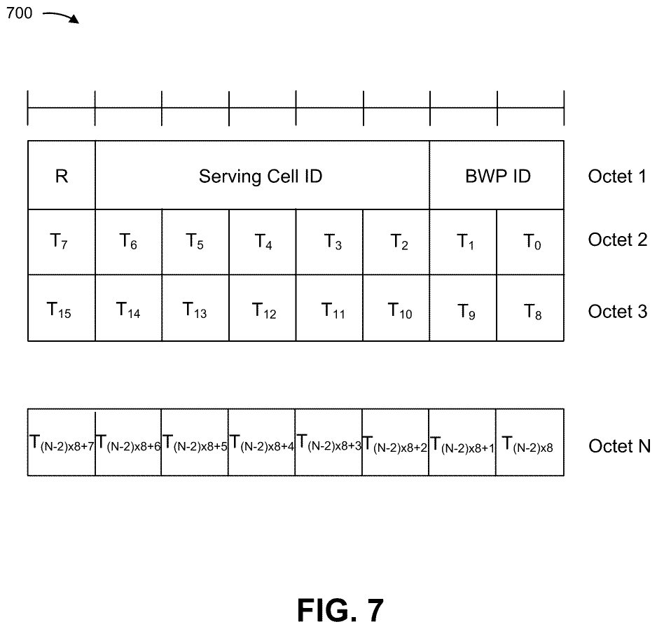

In some cases, K₂ slot offset information can be based at least in part on an aperiodic CSI trigger state, and/or an aperiodic CSI trigger state subselection MAC-CE. For example, FIG. 7 is a diagram illustrating an example of a MAC-CE 700 associated with aperiodic CSI state subselection, in accordance with some examples. Based on the aperiodic CSI trigger state subselection MAC-CE 700, in some cases a maximum of 63 aperiodic trigger states can be down-selected, and a maximum of 128 CSI aperiodic trigger states can be configured (e.g., based on a configuration with maxNrOfCSI-AperiodicTriggers=128). In some examples, an aperiodic trigger state (e.g., of the 63 aperiodic trigger states represented in the aperiodic CSI trigger state subselection MAC-CE 700) can be associated to multiple CSI reports, for example based on using the aperiodic CSI trigger state subselection corresponding to the MAC-CE 700. The aperiodic CSI trigger state subselection MAC-CE 700 can include a reserved field R, a Serving Cell ID field (e.g., indicative of the identity of the Serving Cell for which the MAC-CE 700 is applicable), and a bandwidth part (BWP) ID field (e.g., indicative of a DL BWP for which the MAC CE applies as the codepoint of the DCI bandwidth part indicator field).

The plurality of fields Tᵢ included in the aperiodic CSI trigger state subselection MAC-CE 700 can be used to indicate the selection status of the Aperiodic Trigger States configured within aperiodic TriggerStateList. For example, the field T₀ corresponds to the first trigger state within the list aperiodicTriggerStateList, the field T₁ corresponds to the second trigger state within the list aperiodicTriggerStateList, . . . , etc. If the list does not include an entry with an index i, the MAC entity associated with the MAC-CE 700 can be configured to ignore the Tᵢ field. In some aspects, the Tᵢ field can be set to a value of 1 to indicate that the corresponding Aperiodic Trigger State i is mapped to the codepoint of the DCI CSI request field. The codepoint to which the Aperiodic Trigger State i is mapped can be determined by its ordinal position among all the Aperiodic Trigger States with Tᵢ set to 1. For example, the first Aperiodic Trigger State with the Tᵢ field set to 1 is mapped to the codepoint value 1, the second Aperiodic Trigger State with the Tᵢ field set to 1 is mapped to the codepoint value 2, . . . , etc. The maximum number of mapped Aperiodic Trigger States can be set to 63, for example based on an UL DCI size of 6 bits supporting a maximum of 63 states (e.g., 2⁶=64−1 reserved bit=63 bits available for mapped Aperiodic Trigger States). To implement the maximum of 128 CSI aperiodic trigger states, the down-selection process can be used to set or map the additional Aperiodic Trigger States beyond the maximum of 63, up to the extended maximum of 128 CSI aperiodic trigger states with down-selection.

In some examples, the DCI CSI request field can be configured for use with aperiodic CSI reporting, and/or can be configured for use with aperiodic CSI-RS when the triggering PDCCH and the CSI-RS have the same numerology. For example, the interpretation of the DCI CSI request field can be performed based on one or more configured factors. In some examples, when all bits of the CSI request field in DCI are set to zero, the CSI request field can be interpreted to indicate no CSI is requested.

In another example, when the number of configured CSI triggering states in CSI-Aperiodic TriggerStateList is greater than 2^{NTS}−1, where N_{TS} is the number of bits in the DCI CSI request field, the UE may receive a subselection indication (e.g., corresponding to the CSI trigger state subselection MAC-CE 700 of FIG. 7, etc.). The received subselection indication can be used by the UE to map up to 2^{NTS}−1 aperiodic CSI trigger states to the codepoints of the CSI request field in DCI. In some examples, N_{TS} may be configured by the higher layer parameter reportTriggerSize where N_{TS} E {0, 1, 2, 3, 4, 5, 6}. When the UE would transmit a PUCCH with HARQ-ACK information in a slot n corresponding to the PDSCH carrying the subselection indication, the corresponding action from the aperiodic CSI trigger state subselection MAC-CE 700 and UE assumption on the mapping of the selected CSI trigger state(s) to the codepoint(s) of the DCI CSI request field can be applied starting from the first slot that is after slot

$$n + 3 {N}_{slot}^{subframe , μ} + \frac{{2}^{μ}}{{2}^{{μ}_{{K}_{mac}}}} \cdot {k}_{mac} ,$$

where μ is the subcarrier spacing (SCS) configuration for the PUCCH and μₖ_{_{mac}} represents the subcarrier spacing configuration for k_{mac} with a value of 0 for frequency range 1, and k_{mac} is provided by K-Mac or k_{mac}=0 if K-Mac is not provided.

In another example, when the number of CSI triggering states in CSI-Aperiodic TriggerStateList is less than or equal to 2^{NTS}−1, the CSI request field in DCI can directly indicate the triggering state for the aperiodic CSI report (e.g., directly indicate the aperiodic CSI trigger state).

As noted above, in some examples aperiodic CSI reporting may be configured with different values of K₂ corresponding to different UE processing latency times (e.g., a longer value of K₂ may be used for a scheduling DCI and corresponding aperiodic CSI report than the shorter value of K₂ that may be used for a scheduling DCI and corresponding PUSCH data with or without CSI, based on a longer UE processing time and latency associated with generating the aperiodic CSI report than the PUSCH data transmission).

As noted above, there is a need for systems and techniques that can be used to provide additional or extended UE processing time for various types of PUSCH transmissions scheduled by a DCI, where the UE processing time (e.g., processing latency) can be increased or decreased while using a single K₂ offset value between scheduling DCI and the corresponding PUSCH. Using different values of the K₂ timing offset can increase complexity and reduce efficiency associated with a network entity and/or UE performing aperiodic CSI reporting. For example, performing aperiodic CSI reporting with multiple values of the K₂ timing offset parameter can increase the complexity associated with uplink scheduling and/or associated with an uplink transmission timeline for a UE. In some cases, the complexity of uplink scheduling and the UE uplink timeline may increase when two different K₂ slot offset values are configured from the UL DCI transmission or UL scheduling decision to the PUSHC reception.

In another example, using a single K₂ slot offset for all types of PUSCH transmissions scheduled by a DCI may also decrease efficiency of the aperiodic CSI reporting process, based on the single K₂ slot offset being selected to support the longest processing latency that may be needed for the UE (e.g., the single K₂ slot offset value is selected to be greater than or equal to the longest UE processing latency across all scenarios or types of different PUSCH transmissions scheduled by DCI). A single K₂ slot offset value that is selected to be greater than or equal to the longest UE processing latency can introduce additional delay in the process of UL DCI transmission and PUSCH reception by a network entity (e.g., gNB, base station, etc.), which may correspond to a greater number of HARQ processes. A greater number of HARQ processes can correspond to an increased (e.g., longer) PUSCH retransmission delay.

In some cases, when aperiodic CSI-RS is used as a measurement resource (e.g., a measurement resource associated with an aperiodic CSI report generated and transmitted by the UE, etc.), the network entity may be configured to transmit the aperiodic CSI-RS after the UE finishes UL DCI decoding (e.g., based on the UL DCI indicating to the UE the request for the aperiodic CSI report for which the UE performs measurements of the aperiodic CSI-RS, etc.). The delay between transmitting the scheduling UL DCI from the network entity to the UE to indicate the request for aperiodic CSI report, and the later transmission of the aperiodic CSI-RS for measurement by the UE, can correspond to at least the processing and decoding time for the UL DCI by the UE. The time for the UE to receive and decode the UL DCI indicative of the request for the aperiodic CSI report can be variable, and may be associated with relatively higher values of K₂ (e.g., relatively longer delays) being configured in some examples for aperiodic CSI reporting by a UE.

In some examples, aperiodic CSI reporting based on one or multiple K₂ values may correspond to increased power consumption by a UE. For example, the power consumption of a UE may increase based on the UE performing continuous CSI-RS monitoring and/or continuous CSI-IM monitoring. In some examples, the UE may perform the continuous CSI-RS and/or CSI-IM monitoring based on the unknown aperiodic CSI report timing. For example, if the UE processing time to measure and process CSI-RS and/or CSI-IM for an aperiodic CSI report is greater than the configured K₂ offset value, the UE is unable to generate an aperiodic CSI report within the time delay given by K₂ after receiving the UL DCI requesting the aperiodic CSI report from the UE. In some cases, the UE may monitor every CSI-RS and/or CSI-IM measurement resource or measurement resource occasion (e.g., continuous CSI-RS and/or CSI-IM monitoring) in order to be prepared for generating and transmitting an aperiodic CSI report for the CSI-RS or CSI-IM, should the UE receive at some time in the future a UL DCI indicative of a request for the aperiodic CSI report. In some cases, the UE may perform continuous CSI-RS and/or continuous CSI-IM monitoring in response to the unknown aperiodic CSI report timing, including continuous monitoring of CSI-RS and/or CSI-IM in examples where a timeRestrictionForChannelMeasurements parameter is not configured for the UE, and/or a timeRestrictionForInterferenceMeasurements parameter is not configured for the UE.

In one illustrative example, provided are systems and techniques for early indication signaling of an upcoming request for an aperiodic CSI report. For example, the systems and techniques can be used to provide an indication message transmitted from a network entity to a UE (e.g., received by a UE from a network entity), where the indication message is transmitted before an upcoming (e.g., future, scheduled, etc.) aperiodic CSI report request and where the indication message is indicative of the existence of the upcoming aperiodic CSI report request for the UE. For example, the indication message can be configured as an early indication to inform the UE of the upcoming aperiodic CSI report request (e.g., early indication of aperiodic CSI report). Based on receiving the early indication message for the upcoming aperiodic CSI report request, the UE can be configured to perform one or more measurements for the aperiodic CSI report prior to receiving a request for the aperiodic CSI report. For example, the UE can perform and/or configure one or more CSI-RS measurements and/or one or more CSI-IM measurements corresponding to an aperiodic CSI report, prior to the UE receiving a request for the aperiodic CSI report.

In some aspects, a network entity (e.g., base station, gNB, etc.) can be configured to transmit an indication message to a UE, where the indication message indicates a request for an aperiodic CSI report is scheduled. In some cases, the indication message to the UE may also be referred to as an early indication message and/or a first message. Based on receiving the indication message (e.g., early indication message of an upcoming aperiodic CSI report), the UE can trigger preparations for performing channel and/or interference measurements using one or more CSI-RS and/or CSI-IM resources. In some aspects, the early indication message and the one or more CSI-RS and/or CSI-IM resources may be transmitted by the same network entity (e.g., base station, gNB, etc.). In some examples, the early indication message and a later request for an aperiodic CSI report can be transmitted to the UE by the same network entity (e.g., base station, gNB, etc.).

In some aspects, the early indication message can be transmitted by the network entity based at least in part on UE capability information that indicates the UE is capable of implementing and/or supporting the reception of the early indication message. For example, the network entity may be configured to not send (e.g., skip sending) one or more early indication messages to a UE with capability information explicitly indicating the UE does not support the aperiodic CSI report request early indication, and/or based on the UE capability information not explicitly indicating that the UE does support the aperiodic CSI report request early indication. The transmission of the early indication message for an upcoming aperiodic CSI report request may be performed by the network entity based on a determination (e.g., using the corresponding UE capability information) by the network entity that the UE supports the early indication message signaling.

In some aspects, a network entity (e.g., gNB, base station, etc.) can be configured to provide or transmit to a UE configuration information that is indicative of whether the early indication message signaling is used or not by the network entity for aperiodic CSI reporting. For example, the enablement indication of the early indication aperiodic CSI report request signaling can be signaled as an RRC parameter included in one or more RRC configuration messages transmitted by the network entity and/or received by the UE. For example, a first value of the RRC parameter can indicate that the early indication signaling for aperiodic CSI report requests is enabled (e.g., a value of 1, etc.), and a second value of the RRC parameter can indicate that the early indication signaling for aperiodic CSI report requests is not enabled (e.g., a value of 0, etc.). In some aspects, a network entity may be associated with a plurality of UEs. The network entity can obtain respective UE capability information for each UE of the plurality of UEs, and can identify or determine a first subset of UEs that support the early indication signaling for aperiodic CSI reporting, and a second subset of UEs that do not support the early indication signaling for aperiodic CSI reporting. Based on the respective UE capability to support (or not support) the early indication signaling for aperiodic CSI reporting, the network entity can provide an RRC configuration indicative of enablement of the early indication signaling to the UEs within the first subset, and can provide an RRC configuration not indicative of enablement (or indicative of disablement) of the early indication signaling to the UEs within the second subset.

In one illustrative example, the early indication message to indicate an upcoming request for an aperiodic CSI report (e.g., the early indication message to indicate a request for an aperiodic CSI report is scheduled for transmission to the UE in a later time slot, etc.) may be transmitted via DCI. For example, the network entity can transmit a DCI indicative of the early indication message, to inform the UE of an upcoming aperiodic CSI report request from the network entity. The UE can receive a DCI indicative of the early indication message, indicating to the UE that there is an upcoming aperiodic CSI report request that will be transmitted by the network entity to the UE.

In some cases, the early indication message can be sent via DCI, using a new DCI format that is defined for the early indication message for the aperiodic CSI report. In some cases, the aperiodic CSI report early indication message can be a unicast DCI (e.g., transmitted from the network entity to a single UE), and/or can be a multicast DCI (e.g., group signaling transmitted from the network entity towards a group of multiple UEs including the UE). In some aspects, the aperiodic CSI report early indication message can be implemented using a DCI format that includes one or more parameters associated with the upcoming aperiodic CSI report.

For example, the DCI format used for the early indication message indicative of the upcoming request for an aperiodic CSI report can include and/or indicate an ordinal index of an aperiodic CSI trigger state value. In some cases, the DCI format for the aperiodic CSI reporting early indication DCI message may include the ordinal index of aperiodic CSI trigger state value based on the number of configured aperiodic CSI trigger states being less than or equal to 2^{NTS}−1, where NTs is the number of bits of the CSI request field within the DCI format.

In some aspects, if the number of configured aperiodic CSI trigger states is greater than 2^{NTS}−1, the DCI format used for the early indication message indicative of the upcoming request for an aperiodic CSI report can include a CSI request field value that refers to an ordinal index of sub-selected aperiodic CSI trigger states (e.g., sub-selection based on and/or corresponding to the aperiodic CSI trigger state subselection MAC-CE 700 of FIG. 7, etc.).

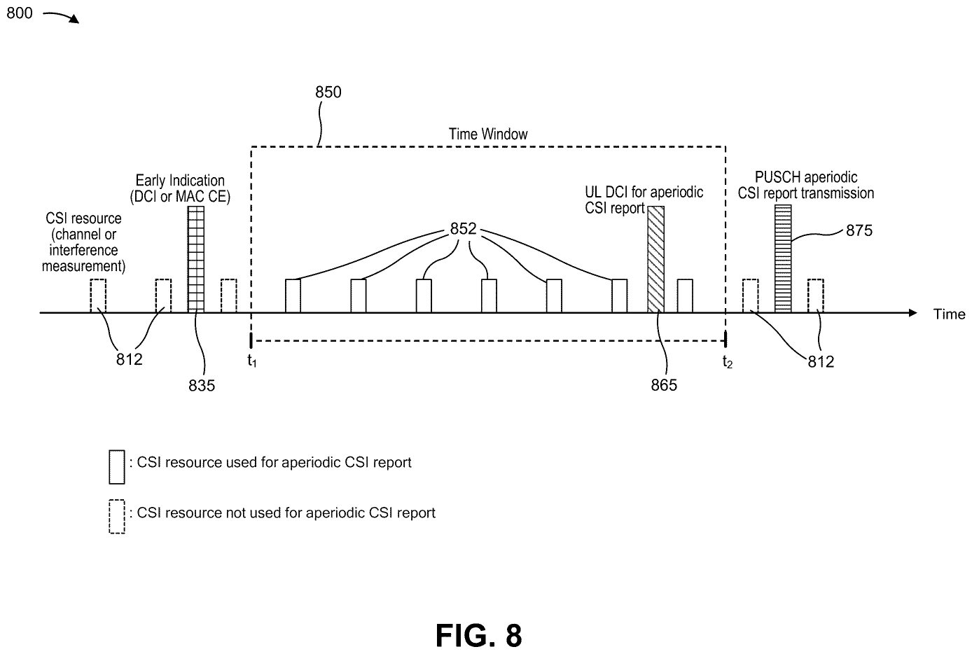

In an illustrative example, the DCI format used for the early indication message indicative of the upcoming request for an aperiodic CSI report can include time window information (e.g., one or more parameters corresponding to information associated with a time window for the aperiodic CSI reporting procedure configured for the UE). For example, FIG. 8 is a diagram illustrating an example of a signaling timeline 800 for an early indication message corresponding to at least one of an UL DCI for an aperiodic CSI report and a PUSCH aperiodic CSI report transmission, in accordance with some examples. The signaling timeline 800 can include a plurality of CSI resources 812, which may be configured as CSI resources for channel measurement (e.g., CSI-RS resources) and/or may be configured as CSI resources for interference measurement (e.g., CSI-IM resources). In the example signaling timeline 800 of FIG. 8, the UE may receive an UL DCI 865 indicative of a request for an aperiodic CSI report. The CSI resources (e.g., of the plurality of CSI resources 812) that are used for generating the aperiodic CSI report corresponding to the request in UL DCI 865 are indicated as the subset of CSI resources 812 shown with a solid line border and are included within a configured time window 850. The CSI resources (e.g., of the plurality of CSI resources 812) that are not used for generating the aperiodic CSI report corresponding to the request in UL DCI 865 are indicated as the subset of CSI resources 812 with a dashed line border, and are located outside of the configured time window 850. For example, the subset of CSI resources not used for generating the aperiodic CSI report requested by UL DCI 865 and included in the PUSCH aperiodic CSI report transmission 875 are the CSI resources 812 before the beginning of the time window 850 (e.g., the CSI resources 812 before time t₁) and the CSI resources 812 after the end of the time window 850 (e.g., the CSI resources 812 after time t₂). In some examples, the subset of CSI resources that are used for generating the aperiodic CSI report requested by the UL DCI 865 and included in the PUSCH aperiodic CSI report transmission 875 are the CSI resources within the time window 850 (e.g., the CSI resources 852 that are after the start time t₁ of time window 850 and before the end time t₂ of time window 850).

In some examples, the early indication message 835 may be sent via DCI, as noted above. In some examples, the early indication message 835 may be sent via MAC-CE (e.g., the early indication message 835 can be a DCI including an indication of the upcoming aperiodic CSI report request of the UL DCI 865, and/or the early indication message 835 can be a MAC-CE including an indication of the upcoming aperiodic CSI report request of the UL DCI 865). In some examples, the early indication message 835 can indicate and/or include one or more parameters of the time window 850. The time window 850 can be the period of time where the UE is configured to perform measurements on one or more CSI resources, where the measurements are channel measurements for the aperiodic CSI report. The channel measurements on the one or more CSI resources can be used by the UE to generate the measurement information for the aperiodic CSI report. In some examples, the early indication message 835 can cause the UE to begin performing CSI resource measurements (e.g., channel measurements) for generating the measurement information for the aperiodic CSI report 875, at a time earlier than when the UE receives the request for the aperiodic CSI report (e.g., the UL DCI 865).

In some examples, the early indication message 835 can be indicative of separate start offset and length values for the time window 850. For example, the early indication message 835 can include a first indicator or value corresponding to the start time t₁ of the time window 850, and the early indication message 835 can include a second indicator or value corresponding to the end time t₂ of the time window 850. In some cases, the early indication message 835 can include separate start offset and length values for the time window 850, and/or the early indication message 835 can include start and length indicator value (SLIV) information corresponding to the time window 850.

In some examples, the early indication message 835 can include an indication of the start offset for the time window 850 (e.g., an indication of the start time t₁ for the time window 850) without including an indication of the length of the time window 850 (e.g., without including an explicit indication of the end time t₂ of the time window 850). In some cases, the UE can be configured to determine or obtain the time window 850 start time t₁ from the early indication message 835, and can determine the end time t₂ for the time window 850 relative to the slot with the UL DCI 865 for the actual aperiodic CSI report. For example, the time window 850 can end in the same slot that the UE receives the UL DCI 865 with the request for the aperiodic CSI report, and/or can end in the slot after the slot in which the UE receives the UL DCI 865 indicative of the request for the aperiodic CSI report, etc. In another example, the early indication message 835 omits the time window 850 information, and the UE can be configured to implement an implicit time window 850 start time t₁ and/or an implicit time window 850 end time t₂ and/or an implicit time window 850 length (e.g., t₂-t₁).

In some aspects, an early indication message 835 associated with implicit configuration of the time window 850 can cause the UE to determine the time window 850 based on the UL DCI 835 for the early indication of the request for the aperiodic CSI report and the UL DCI 865 for the actual request for the aperiodic CSI report. In some aspects, implicit configuration of the time window 850 can correspond to a time window 850 start time t₁ that is the same as the slot or time when the UE receives the early indication message 835 (e.g., the UE begins monitoring CSI resources for CSI-RS and/or CSI-IM for the aperiodic CSI report beginning from the time the UE receives the early indication message 835). In some examples, implicit configuration of the time window 850 can correspond to a time window 850 end time t₂ that is the same as the slot or time when the UE receives the actual request for the aperiodic CSI report in the UL DCI 865. In another example, implicit configuration of the time window 850 can correspond to a time window 850 end time t₂ that is the same as, or that corresponds to, the slot or time when the UE transmits the PUSCH aperiodic CSI report transmission 875.

In some examples, the early indication message 835 with omitted (e.g., implicit) time window 850 information for the start time t₁ and/or the end time t₂ can be implemented based on UE capability information for the early indication signaling procedure for the aperiodic CSI reporting. For example, the UE capability may indicate that the UE supports determining the start and/or end of the time window 850 with respect to the UL DCI for the early indication 835 and the UL DCI for the CSI report request 865, and based on the UE capability the network entity can transmit the early indication message 835 without explicit configuration of or values for the time window 850 start time t₁ and/or the time window 850 end time t₂. In another example, the UE capability may indicate that the UE does not support determining the start and/or end of the time window 850 with respect to the UL DCI for the early indication 835 and the UL DCI for the actual CSI report request 865, and based on such UE capability the network entity can be configured to transmit the early indication message 835 to include an explicit configuration for, or explicit values for, the time window 850 start time t₁ and/or the time window 850 end time t₂.

In some aspects, the early indication message 835 can be transmitted by the network entity (and received by the UE) using an existing UL DCI format, where the UL DCI format is extended with an additional one bit indicator indicative of the early indication UL DCI type. In some examples, the additional one bit indicator indicative of the early indication UL DCI type may also be referred to as an “early indication field.” In some aspects, the early indication message 835 can be transmitted by the network entity (and received by the UE) using an existing UL DCI format, where the UL DCI format uses the CSI request field to signal the early indication of the aperiodic CSI report request. In some cases, the CSI request field can be referred to as an “early indication field” (e.g., the early indication field can be an additional one bit indicator included in the UL DCI, and/or the early indication field can be implemented using the CSI request field, etc.).

For example, in some cases the UL DCI format can be extended to include a 1-bit indicator (e.g., an early indication field, with a length of 1-bit) to distinguish whether the UL DCI (e.g., the UL DCI including the 1-bit indicator as the early indication field) is an UL DCI for the early indication message 835, or is an UL DCI for the actual aperiodic CSI report request 865. A first value of the 1-bit indicator (e.g., 1) within the early indication field can be used to indicate the UL DCI early indication message type, and a second value of the 1-bit indicator (e.g., 0) within the early indication field can be used to indicate the UL DCI for the actual aperiodic CSI report request. In some cases, the 1-bit indicator (e.g., early indication field) can be subsumed into the CSI request field of the UL DCI format. For example, the CSI request field of size X bits can be extended to a size of (X+1) bits, for a CSI request field that includes the original X bits of CSI request information and the additional 1 bit of the indicator for the early indication message UL DCI type or the actual aperiodic CSI report request UL DCI type (e.g., the additional 1 bit for the early indication field).

In another example, the CSI request field can be reused to signal the early indication message 835 for the aperiodic CSI report request 865. For example, in some aspects each aperiodic CSI trigger state can be mapped to a respective first and second trigger state index. For each aperiodic CSI trigger state, the respective first trigger state index may be mapped to the aperiodic CSI report trigger (e.g., the aperiodic CSI report request 865), and the respective second trigger state index can be mapped to the early indication message 835. In some examples, the mapping rule between aperiodic CSI trigger states and two respective trigger state indices can be implemented based on configuration information associated with the network, and/or can be implemented based on configuration information signaled via RRC between the network entity and the UE. In some cases, the first and second indices mapped to each aperiodic CSI trigger state may be down-selected independently using an aperiodic CSI trigger state subselection MAC-CE (e.g., such as the aperiodic CSI trigger state subselection MAC-CE 700 of FIG. 7, etc.). For example, a first aperiodic CSI trigger state subselection MAC-CE can be used for the trigger state, and a second aperiodic CSI trigger state subselection MAC-CE can be used for the subselection between the first and second indices mapped to the selected aperiodic trigger state. In some examples, the CSI request field value can correspond to the sub-selected trigger state. In some cases, a larger number of aperiodic trigger states and/or larger bit size of the CSI request field can be used.

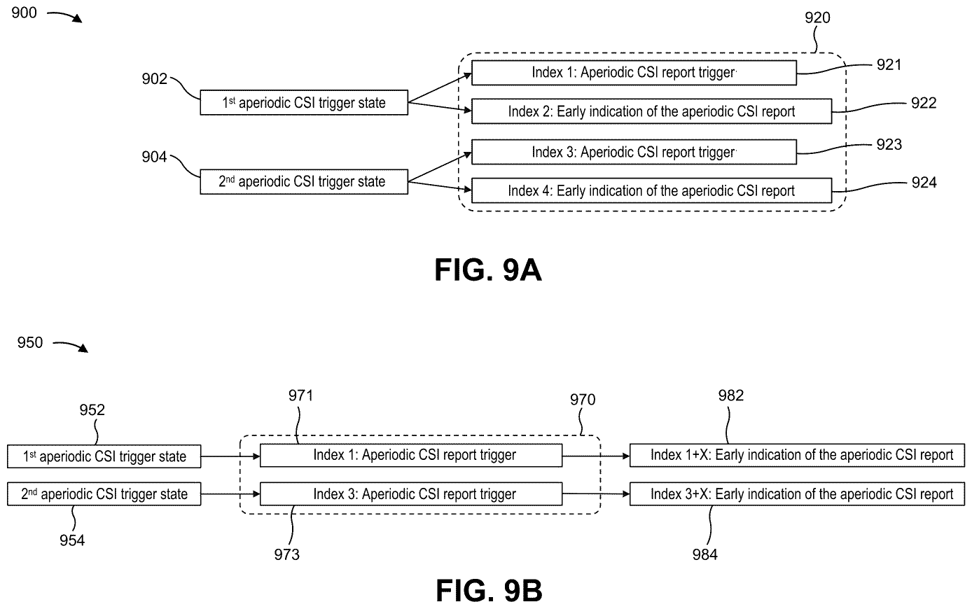

FIG. 9A is a diagram illustrating a first example of a mapping 900 between aperiodic CSI trigger states and respective trigger state indices, in accordance with some examples. For example, a first aperiodic CSI trigger state 902 can be mapped to a respective first trigger state index 921 and a respective second trigger state index 922. The first trigger state index 921 mapped to the first aperiodic CSI trigger state 902 can correspond to the actual aperiodic CSI report trigger. The second trigger state index 922 mapped to the first aperiodic CSI trigger state 902 can correspond to the early indication message for the aperiodic CSI report request. In another example, a second aperiodic CSI trigger state 904 can be mapped to a respective first trigger state 923 and a respective second trigger state 924. The first trigger state 923 can correspond to the actual aperiodic CSI report trigger for the second aperiodic CSI trigger state 904. The second trigger state 924 can be mapped to the early indication message for the aperiodic CSI report request for the second aperiodic CSI trigger state 904. Based on each trigger state of a plurality of aperiodic CSI trigger states (e.g., 902, 904, etc.) being mapped to a respective two indices, the plurality of indices 920 can comprise a set of candidates for subselection 920.

In another illustrative example, each aperiodic CSI trigger state can be mapped to a corresponding, single trigger state index. The subselection process can be performed by MAC-CE (e.g., using the aperiodic CSI trigger state subselection MAC-CE 700 of FIG. 7, etc.) for the individual aperiodic CSI trigger states and corresponding mapped indices. For example, FIG. 9B is a diagram illustrating a second example of a mapping 950 between aperiodic CSI trigger states and a respective trigger state index, in accordance with some examples. A first aperiodic CSI trigger state 952 can correspond to the first aperiodic CSI trigger state 902 of FIG. 9A. A second aperiodic CSI trigger state 954 can correspond to the second aperiodic CSI trigger state 904 of FIG. 9A.

The first aperiodic CSI trigger state 952 can be mapped to the single aperiodic CSI report trigger state index 971, and the second aperiodic CSI trigger state 954 can be mapped to the single aperiodic CSI report trigger state index 973. The candidates for subselection can comprise the set of indices 970, where the set of indices 970 includes a number of aperiodic CSI report trigger state indices equal to the number of aperiodic CSI trigger states (e.g., based on each aperiodic CSI trigger state being mapped to a single aperiodic CSI report trigger state index). Based on the subselection within the set of indices 970, the first aperiodic CSI report trigger state index 971 can be sub-selected to Index 1+X 982, corresponding to the early indication of the aperiodic CSI report request for the first aperiodic CSI trigger state 952. Based on the subselection within the set of indices 970, the second aperiodic CSI report trigger state index 973 can be sub-selected to Index 3+X 984, corresponding to the early indication of the aperiodic CSI report request for the second aperiodic CSI trigger state 954.

In some cases, after performing the sub-selection over the set of candidates 970 comprising the single trigger state index for each aperiodic CSI trigger state, each aperiodic CSI trigger state can be given the additional index value based on an implicit rule indicated by the CSI request field. The additional index value can be the index value for the early indication of the aperiodic CSI report request (e.g., the additional index value 1+X 982 for the first aperiodic CSI trigger state 952, the additional index value 3+X 984 for the second aperiodic CSI trigger state 954, etc.). In some examples, a larger number of aperiodic trigger states and/or larger bit size of the CSI request field can be used.

In some examples, the early indication message 835 of FIG. 8 can be sent via DCI, as noted above. The UL DCI format can be extended to include a combination of parameter values that are configured to indicate that the UL DCI comprises an early indication message 835. In some cases, the combination of parameter values in the UL DCI can indicate the UL DCI is an early indication of an aperiodic CSI report request corresponding to a particular aperiodic CSI trigger state. The particular aperiodic CSI trigger state can be indicated by the CSI request field of the UL DCI, in some examples. In some aspects, the UL DCI for the early indication message 835 can still have a valid PUSCH allocation, corresponding to a PUSCH transport block (TB) without CSI report, even though the CSI request field has a non-zero value.

In another illustrative example, the early indication message 835 can be sent via MAC-CE. For example, the early indication message 835 can be indicated by and/or included in a MAC-CE transmitted by a network entity and received by a UE. In some cases, the early indication message 835 can be a MAC-CE using a MAC-CE format including one or more configured parameters for the early indication message. In some aspects, the MAC-CE format can include one or more parameters indicative of a serving cell index. In some examples, the MAC-CE format can include one or more parameters indicative of an ordinal index of the aperiodic CSI trigger state value, in cases where the number of configured aperiodic CSI trigger states is less than or equal to 2^{NTS}−1, where N_{TS} is the number of bits of the CSI request field within the MAC-CE format.

In some aspects, if the number of configured aperiodic CSI trigger states is greater than 2^{NTS}−1, the MAC-CE format used for the early indication message 835 indicative of the upcoming request 865 for the aperiodic CSI report can include a CSI request field value that refers to an ordinal index of sub-selected aperiodic CSI trigger states (e.g., sub-selection based on and/or corresponding to the aperiodic CSI trigger state subselection MAC-CE 700 of FIG. 7, etc.).

In some examples, the early indication message 835 can use a MAC-CE format configured to indicate and/or include one or more parameters of the time window 850. The time window 850 can be the period of time where the UE is configured to generate the measurement information for the aperiodic CSI report. For example, within (e.g., during) the time window 850, the UE may be configured to perform measurements on one or more CSI resources, where the measurements are channel measurements corresponding to the aperiodic CSI report. Based on the channel measurements performed on the one or more CSI resources, the UE can generate the measurement information for the aperiodic CSI report (e.g., generate the measurement information using the channel measurements performed on the one or more CSI resources). In some cases, the early indication message 835 MAC-CE format can cause the UE to begin performing CSI resource measurements (e.g., channel measurements) for generating the measurement information for the aperiodic CSI report 875, at a time earlier than when the UE receives the request for the aperiodic CSI report (e.g., the UL DCI 865).

In some examples, the early indication message 835 MAC-CE format can be indicative of separate start offset and length values for the time window 850. For example, the early indication message 835 MAC-CE format can include a first indicator or value corresponding to the start time t₁ of the time window 850, and the early indication message 835 MAC-CE format can include a second indicator or value corresponding to the end time t₂ of the time window 850. In some cases, the early indication message 835 MAC-CE format can include separate start offset and length values for the time window 850, and/or the early indication message 835 MAC-CE format can include start and length indicator value (SLIV) information corresponding to the time window 850.

In some examples, the early indication message 835 MAC-CE format can include an indication of the start offset for the time window 850 (e.g., an indication of the start time t₁ for the time window 850) without including an indication of the length of the time window 850 (e.g., without including an explicit indication of the end time t₂ of the time window 850). In some cases, the UE can be configured to determine or obtain the time window 850 start time t₁ from the early indication message 835 MAC-CE format, and can determine the end time t₂ for the time window 850 relative to the slot with the UL DCI 865 for the actual aperiodic CSI report. For example, the time window 850 can end in the same slot that the UE receives the UL DCI 865 with the request for the aperiodic CSI report, and/or can end in the slot after the slot in which the UE receives the UL DCI 865 indicative of the request for the aperiodic CSI report, etc. In another example, the early indication message 835 MAC-CE format omits the time window 850 information, and the UE can be configured to implement an implicit time window 850 start time t₁ and/or an implicit time window 850 end time t₂ and/or an implicit time window 850 length (e.g., t₂-t₁). In some cases, when an absolute end timing of the time window 850 is provided to the UE, the UE can be configured with an assumption that the aperiodic CSI report trigger will be received near the end of the time window 850, and that the UE will transmit back to the network entity in response the predicted and/or extrapolated aperiodic CSI report.

In an illustrative example, when the early indication message 835 of the aperiodic CSI report request is received by the UE, the UE can determine a measurement configuration from the early indication message 835, where the determined measurement configuration is used by the UE to generate the measurement information for the aperiodic CSI report. In some aspects, the determined measurement configuration can be used by the UE to obtain one or more channel measurements, where the UE then uses the one or more channel measurements to generate the measurement information for the aperiodic CSI report (e.g., generates the measurement information based on and/or using the one or more channel measurements). For example, the determined measurement configuration from the early indication message 835 can be used to configure the UE behavior for CSI-RS and/or CSI-IM and/or SSB measurements corresponding to the aperiodic CSI report. Based on obtaining one or more CSI-RS and/or CSI-IM and/or SSB measurements, the UE can generate the measurement information for the aperiodic CSI report. In some examples, the measurement configuration determined from the early indication message 835 can be indicative of the time window for SSB (periodic) and/or periodic or semi-persistent CSI-RS and/or CSI-IM. The time window may be the same as or similar to the time window 850 of FIG. 8. In some cases, the time window definition can correspond to the time window definition information used for the time window 850 of FIG. 8. In some examples, the UE is configured based on the determined measurement configuration from the early indication message 835 to only perform SSB and/or CSI-RS and/or CSI-IM measurements (e.g., collectively referred to as channel measurements, which may be used for generating the measurement information for the aperiodic CSI report) within the time window 850 configured by the early indication message 835. In some aspects, even when the timeRestrictionForChannelMeasurements parameter and/or the parameter timeRestrictionForInterferenceMeasurements are not configured, the UE channel measurements of the SSB, CSI-RS, and/or CSI-IM resources may still be restricted during the window. By restricting the measurements during the window, the UE power consumption for CSI-RS and/or CSI-IM and/or SSB measurements can be reduced.

In some cases, the measurement configuration determined from the early indication message 835 can be indicative of a time offset applied for aperiodic CSI-RS and/or CSI-IM. The aperiodicTriggeringOffset value can be used to determine the slot having aperiodic CSI-RS and/or CSI-IM and/or SSB, where the determined slot is determined with respect to (e.g., relative to) the slot having the UL DCI. In some cases, when the early indication message 835 is transmitted (e.g., enabled, used, etc.), the UE can be configured with an assumption that there will be no aperiodic CSI-RS and/or CSI-IM and/or SSBN after the UL DCI that actually triggers the aperiodic CSI report request (e.g., the second UL DCI, such as the UL DCI 865 for the aperiodic CSI report request of FIG. 8, etc.).

In some aspects, the systems and techniques can use the early indication message 835 to configure the UE CPU occupation based on information of the early indication message 835. For example, a UE may perform multiple CSI report operations that are processed in parallel. The limited software and/or hardware computational capabilities of the UE can correspond to a concept of CPU occupation for CSI report operations by the UE, where the CPU occupation is a percentage out of the maximum CSI report operations that can be performed by the UE at a particular time and/or for particular load or other processing conditions at the UE. The UE CPU occupation can be configured to capture UE-side capability and availability, and may be used to reserve resources of the UE for processing a CSI measurement and report for each early indication message 835 that is received indicative of an upcoming aperiodic CSI report request for the UE.

In one illustrative example, the start of the CPU occupation at the UE can be triggered relative to the reception time of the early indication message by the UE. For example, a CPU occupation for performing the aperiodic CSI report can be triggered for the UE at the time the UE receives the early indication message 835 of FIG. 8. In some cases, the CPU can be assumed to be occupied from X (≥0) symbols after the slot or symbol with the early indication message 835 (e.g., where the early indication message 835 received in the slot or symbol may be a DCI or MAC-CE). In some aspects, the start of the CPU occupation for the aperiodic CSI report can be triggered for the UE relative to the first CSI resource (e.g., CSI-RS, CSI-IM, etc.) within the time window (e.g., time window 850 of FIG. 8) after receiving the early indication message 850 of FIG. 8. For example, the CPU of the UE can be assumed to be occupied from X (≥0) symbols after the first CSI resource 852 within the configured time window 850, where the first CSI resource and/or the time window are determined based on the measurement configuration information indicated within the early indication message 835 DCI or MAC-CE. In some examples, the end of the UE CPU occupation can be triggered or determined based on the expiration of a configured number of symbols after the end of the time window 850. For example, the end of the UE CPU occupation for performing the aperiodic CSI report can be determined as Y symbols after the end (e.g., end time t₂) of the configured time window 850 for the early indication message 835 of FIG. 8.

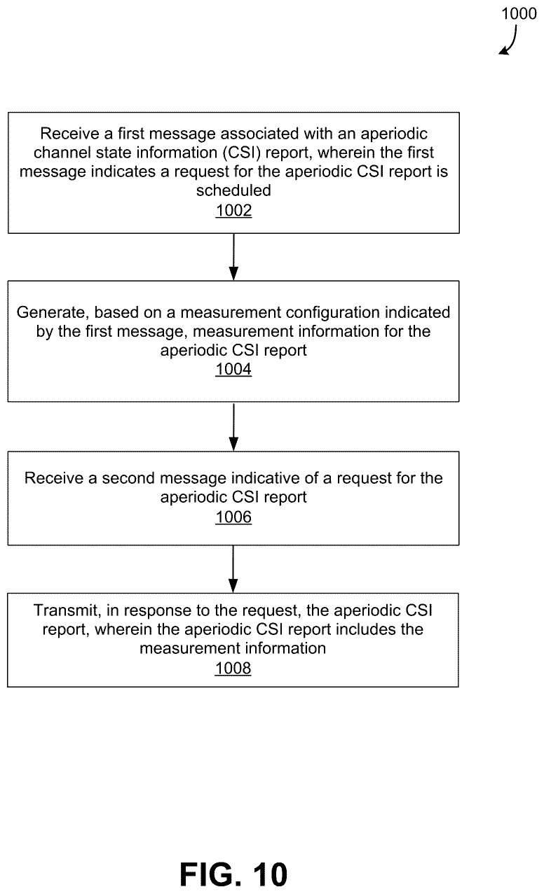

FIG. 10 is a flowchart diagram illustrating an example of a process 1000 for wireless communications. In some aspects, the process 1000 can be a process for wireless communications by a network entity (e.g., a UE, etc.). For example, the process 1000 can be a process for wireless communications by a UE. In some examples, the process 1000 can be performed by a network entity or network device (or apparatus) or a component (e.g., a chipset, codec, etc.) of the network entity or device. The process 1000 can be performed by one or more processors such as one or more CPUs, DSPs, NPUs, NSPs, microcontrollers, ASICs, FPGAs, programmable logic devices, discrete gates or transistor logic components, discrete hardware components, etc., any combination thereof, and/or other component or system) of the network entity or device or apparatus. The operations of the process 1000 may be implemented as software components that are executed and run on one or more processors (e.g., processor 1110 and/or processing system 1102 of FIG. 11, or other processor(s)).

In some examples, the process 1000 can be performed by a UE, including any of the various UEs described herein. In some aspects, the process 1000 can be performed by a UE, smartphone, mobile computing device, user computer device, etc. The process 1000 can be performed by a component or system (e.g., a chipset) of a network device (e.g., one or more of UEs 104, 152, 164, 182, 190 of FIG. 1; UE 104 of FIG. 2; UE(s) 104 of FIG. 3; wireless device 407 of FIG. 4; computing system 1100 and/or processing system 1102 of FIG. 11; etc.). The network device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 1000 may be implemented as software components that are executed and run on one or more processors (e.g., the transmit processor 264, the receive processor 258, the TX MIMO processor 266, the MIMO detector 256 of FIG. 2, the processing system 470 of FIG. 4, the processor(s) 484 of FIG. 4, the processing system 1102 of FIG. 11, and/or the processor 1110 of FIG. 11, or other processor(s) (e.g., such as one or more other processors included within and/or associated with the processing system 470 of FIG. 4, the processing system 1102 of FIG. 11, etc.). Further, the transmission and reception of signals by the network entity in the process 1000 may be enabled, for example, by one or more antennas, one or more transceivers (e.g., wireless transceiver(s)), and/or other communication components (e.g., the transmit processor 264, the receive processor 258, the TX MIMO processor 266, the MIMO detector 256, the modulator(s)/demodulator(s) 254a through 254t, and/or the antenna(es) 252a through 252t of FIG. 2, the antenna(es) 487 of FIG. 4, the wireless transceiver(s) 478 of FIG. 4, the communication interface 1140 of FIG. 11, or other antennae(s), transceiver(s), and/or component(s)).

At block 1002, the network entity (or component thereof) can receive a first message associated with an aperiodic channel state information (CSI) report, wherein the first message indicates a request for the aperiodic CSI report is scheduled. For example, the first message can be an early indication of an upcoming request for the aperiodic CSI report. In some cases, the first message can correspond to the early indication message 835 of FIG. 8, and the upcoming request for the aperiodic CSI report can correspond to the UL DCI for the aperiodic CSI report request 865 of FIG. 8.

In some cases, the first message can be associated with a first transmission time. For example, the first transmission time can correspond to a transmission time of the early indication message 835 of FIG. 8. The first message can be indicative of an upcoming request for the aperiodic CSI report at a second transmission time later than the first transmission time. For example, the second transmission time can correspond to the transmission time of the UL DCI for the aperiodic CSI report request 865 of FIG. 8, later than the transmission time of the early indication message 835 of FIG. 8.

In some examples, the network entity (or component thereof) can be configured to receive a radio resource control (RRC) message from a second network entity, such as a base station, gNB, etc. The RRC message can enable a configuration for aperiodic CSI reporting. For example, the RRC message can enable an early indication configuration for aperiodic CSI reporting, where the early indication configuration corresponds to the use of the early indication message 835 of FIG. 8. The network entity (or component thereof) can receive the first message based on the configuration. In some examples, the first message comprises downlink control information (DCI) including an indication the request for the aperiodic CSI report is scheduled. For example, the first message can comprise the early indication DCI 835 of FIG. 8, including an indication the UL DCI request for the aperiodic CSI report 865 is scheduled.

In some examples, the first message is an uplink (UL) DCI including an early indication field equal to a first value, where the first value corresponds to an UL DCI configuration for early indication of the request for the aperiodic CSI report. For example, the first message can be an UL DCI used to implement the early indication message 835 of FIG. 8, etc. A second message can be an UL DCI including the early indication field equal to a second value, where the second value corresponds to an UL DCI configuration for the request for the aperiodic CSI report. For example, the first message can be the early indication message 835, transmitted as an UL DCI with a first value within the early indication field. The second message can be the UL DCI aperiodic CSI report request 865, transmitted as an UL DIC with a second value within the early indication field. In some cases, the first message is a first uplink (UL) DCI received from a second network entity, such as a base station, gNB, etc. The second message can be a second UL DCI received from the second network entity.

The network entity (or component thereof) can be configured to identify the first UL DCI as an early indication of the request for the aperiodic CSI report based on corresponding aperiodic CSI trigger state information associated with the first UL DCI. For example, the corresponding aperiodic CSI trigger state information can correspond to one or more of the aperiodic CSI trigger states 902 or 904 of FIG. 9A, the aperiodic CSI report triggers 921 or 923 of FIG. 9A, the early indication of the aperiodic CSI report triggers 922 or 924 of FIG. 9A, etc. In some examples, the corresponding aperiodic CSI trigger state information can correspond to one or more of the aperiodic CSI trigger states 952 or 954 of FIG. 9B, the aperiodic CSI report trigger 971 or 973 of FIG. 9B, etc.

In some cases, the first UL DCI can be associated with an aperiodic CSI trigger state mapped to an aperiodic CSI trigger state index corresponding to the early indication. For example, the aperiodic CSI trigger state can be the same as or similar to the aperiodic CSI trigger state 902 or 904 of FIG. 9A, mapped to the aperiodic CSI trigger state index 922 or 924 (respectively) corresponding to the early indication. In another example, the aperiodic CSI trigger state can be the same as or similar to the aperiodic CSI trigger state 952 or 954 of FIG. 9B, mapped to the aperiodic CSI trigger state index 982 or 984 (respectively) corresponding to the early indication.

In some examples, the second UL DCI is associated with an aperiodic CSI trigger state mapped to an aperiodic CSI trigger state index corresponding to the request. For example, the second UL DCI can be associated with the aperiodic CSI trigger state 902 mapped to aperiodic CSI trigger state index 921 corresponding to the request for the report, and/or can be associated with the aperiodic CSI trigger state 904 mapped to the aperiodic CSI trigger state index 923 corresponding to the request for the report. In another example, the second UL DCI can be associated with aperiodic CSI trigger state 952 mapped to the aperiodic CSI report trigger 971, and/or the aperiodic CSI trigger state 954 mapped to the aperiodic CSI report trigger 973, etc. In some cases, the first message can comprise a media access control (MAC) control element (MAC-CE), where the MAC-CE includes an indication the request for the aperiodic CSI report is scheduled, and where the MAC-CE includes an additional indication of a serving cell index.

At block 1004, the network entity (or component thereof) can generate, based on a measurement configuration indicated by the first message, measurement information for the aperiodic CSI report. In some cases, the measurement configuration can include an indication of a particular aperiodic CSI trigger state value of a configured plurality of aperiodic CSI trigger state values. In some examples, the measurement configuration is indicative of a configured time window corresponding to the measurement information. The configured time window can be the same as or similar to the time window 850 of FIG. 8. In some cases, the network entity (or component thereof) can generate the measurement information based on performing measurements of one or more configured reference signals received within the configured time window. For example, the measurement information can be generated based on performing measurements of one or more configured reference signals corresponding to the CSI resources 852 within the time window 850 of FIG. 8.

In some cases, the network entity (or component thereof) can be configured to allocate computational resources to process the aperiodic CSI report using a start time associated with reception of the first message, or a start time corresponding to a first CSI resource within a configured time window indicated by the measurement configuration. For example, the start time associated with reception of the first message can be the reception time associated with early indication message 835 of FIG. 8. The start time corresponding to the first CSI resource within the configured time window can be the same as or similar to the reception time of the first CSI resource 852 within the configured time window 850 of FIG. 8.

In some examples, the measurement information can be generated using at least one of CSI reference signal (CSI-RS) measurements, CSI interference management (CSI-IM) measurements, or synchronization signal block (SSB) measurements. In some cases, to generate the measurement information, the network entity (or component thereof) can be configured to determine, based on the measurement configuration, a configured time window corresponding to a set of reference signal (RS) measurement resources or interference management (IM) measurement resources for the aperiodic CSI report. The configured time window can be the time window 850 of FIG. 8. The set of RS or IM measurement resources for the aperiodic CSI report can be the same as or similar to the CSI resources 852 of FIG. 8. The network entity (or component thereof) can monitor, according to the measurement configuration, the set of RS measurement resources or IM measurement resources during the configured time window to obtain one or more channel measurements. The network entity (or component thereof) can generate the measurement information using the one or more channel measurements.

In some examples, the measurement configuration can be indicative of a set of aperiodic CSI reference signal (CSI-RS) or CSI interference management (CSI-IM) measurement occasions within the configured time window, such as the set of CSI resource measurement occasions 852 within the time window 850 of FIG. 8. The one or more channel measurements can comprise respective measurements obtained for the set of CSI-RS or CSI-IM measurement occasions within the configured time window. In some cases, the network entity (or component thereof) can be configured to monitor the set of RS measurement resources or IM measurement resources only within the configured time window.

In some examples, to generate the measurement information, the network entity (or component thereof) can be configured to obtain one or more channel measurements according to transmission timing offset information indicated by the measurement configuration, where the one or more channel measurements include at least one of CSI reference signal (CSI-RS) measurements or CSI interference management (CSI-IM) measurements. The network entity (or component thereof) can generate the measurement information using the one or more channel measurements. In some cases, the network entity (or component thereof) can be configured to determine the transmission timing offset information relative to a slot associated with the first message or relative to a slot associated with the second message.

At block 1006, the network entity (or component thereof) can receive a second message indicative of a request for the aperiodic CSI report. For example, the second message can be an UL DCI comprising a request for the aperiodic CSI report. In some examples, the second message can correspond to the UL DCI for the aperiodic CSI report request 865 of FIG. 8. The second message may correspond to one or more of the DCI scheduling PUSCH 612 of FIG. 6A, the DCI scheduling PUSCH 632 of FIG. 6B, and/or the DCI scheduling PUSCH 652 of FIG. 6C, etc. In some examples, to receive the second message, the network entity (or component thereof) can be configured to receive an uplink (UL) downlink control information (DCI) indicative of the request for the aperiodic CSI report. The network entity (or component thereof) can decode the UL DCI to determine the request for the aperiodic CSI report, and can generate the measurement information before the UL DCI is decoded. For example, the measurement information can be generated before the UL DCI for the aperiodic CSI report request 865 of FIG. 8 has been decoded by the UE.

In some cases, the first message comprises downlink control information (DCI) including an indication the request for the aperiodic CSI report is scheduled. In some examples, the first message is an uplink (UL) DCI including an early indication field equal to a first value, where the first value corresponds to an UL DCI configuration for early indication of the request for the aperiodic CSI report. In some examples, the second message is an UL DCI including the early indication field equal to a second value, where the second value corresponds to an UL DCI configuration for the request for the aperiodic CSI report.

At block 1008, the network entity (or component thereof) can transmit, in response to the request, the aperiodic CSI report, wherein the aperiodic CSI report includes the measurement information. For example, the network entity can transmit the PUSCH aperiodic CSI report transmission 875 of FIG. 8, in response to the request indicated by the UL DCI for the aperiodic CSI report request 865 of FIG. 8. The aperiodic CSI report of the PUSCH aperiodic CSI report transmission 875 of FIG. 8 can include the measurement information determined based on the one or more measurements of the CSI resources 852 within the configured time window 850 indicated by the early indication message 835 of FIG. 8.

In some examples, the processes described herein (e.g., process 1000 and/or other process described herein) may be performed by a computing device or apparatus (e.g., a network node such as a UE, base station, a portion of a base station, etc.). For example, as noted above, the process 1000 may be performed by a UE and/or network entity (e.g., base station, gNB, etc.). In some examples, the process 1000 may be performed by a computing device with the computing system 1100 shown in FIG. 11. For example, a wireless communication device with the computing architecture shown in FIG. 11 may include the components of the UE and/or the network entity (e.g., base station, gNB, etc.) and may implement the operations of FIG. 10 and/or process 1000, etc.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The process 1000 is illustrated as a logical flow diagram, the operation of which represents a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the process 1000 and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 11 is a diagram illustrating an example of a system for implementing certain aspects of the present technology. In particular, FIG. 11 illustrates an example of computing system 1100 including a processing system 1102, which may be for example any computing device making up internal computing system, a remote computing system, a camera, or any component thereof in which the components of the system are in communication with each other using connection 1105. Connection 1105 may be a physical connection using a bus, or a direct connection into processor 1110 (and/or one or more other processors included within and/or associated with the processing system 1102), such as in a chipset architecture. Connection 1105 may also be a virtual connection, networked connection, or logical connection.

In some aspects, computing system 1100 and/or the processing system 1102 can be provided as a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

The example processing system 1102 includes at least one processing unit (CPU or processor) 1110 and connection 1105 that communicatively couples various system components including system memory 1115, such as read-only memory (ROM) 1120 and random access memory (RAM) 1125 to processor 1110. The processing system 1102 may include a cache 1112 of high-speed memory connected directly with, in close proximity to, or integrated as part of processor 1110 and/or one or more other processors included within and/or associated with the processing system 1102.

Processor 1110 may include any general-purpose processor and a hardware service or software service, such as services 1132, 1134, and 1136 stored in storage device 1130, configured to control processor 1110 and/or one or more other processors included within and/or associated with the processing system 1102, as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, processing system 1102 includes an input device 1145, which may represent any number of input mechanisms, such as a microphone for speech, a touch-sensitive screen for gesture or graphical input, keyboard, mouse, motion input, speech, etc. Processing system 1102 may also include output device 1135, which may be one or more of a number of output mechanisms. In some examples, multimodal systems may enable a user to provide multiple types of input/output to communicate with processing system 1102.

Processing system 1102 may include communications interface 1140, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1140 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1130 may include software services, servers, services, etc., that when the code that defines such software is executed by the processor 1110 and/or one or more other processors included within and/or associated with the processing system 1102, it causes the system to perform a function. In some aspects, a hardware service that performs a particular function may include the software component stored in a computer-readable medium in connection with the necessary hardware components, such as processor 1110 (e.g., and/or one or more other processors included within and/or associated with the processing system 1102), connection 1105, output device 1135, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some examples the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other examples, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“≥”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:
Aspect 1. A network entity for wireless communication, comprising: a processing system configured to: receive a first message associated with an aperiodic channel state information (CSI) report, wherein the first message indicates a request for the aperiodic CSI report is scheduled; generate, based on a measurement configuration indicated by the first message, measurement information for the aperiodic CSI report; receive a second message indicative of a request for the aperiodic CSI report; and transmit, in response to the request, the aperiodic CSI report, wherein the aperiodic CSI report includes the measurement information.
Aspect 2. The network entity of Aspect 1, wherein: to receive the second message, the processing system is configured to receive an uplink (UL) downlink control information (DCI) indicative of the request for the aperiodic CSI report; the processing system is configured to decode the UL DCI to determine the request for the aperiodic CSI report; and the processing system is configured to generate the measurement information before the UL DCI is decoded.
Aspect 3. The network entity of any of Aspects 1 to 2, wherein the first message is an early indication of the request for the aperiodic CSI report.
Aspect 4. The network entity of any of Aspects 1 to 3, wherein the first message is associated with a first transmission time, and wherein the first message is indicative of an upcoming request for the aperiodic CSI report at a second transmission time later than the first transmission time.
Aspect 5. The network entity of any of Aspects 1 to 4, wherein the processing system is configured to: receive a radio resource control (RRC) message from a second network entity, wherein the RRC message enables a configuration for aperiodic CSI reporting; and receive the first message based on the configuration.
Aspect 6. The network entity of any of Aspects 1 to 5, wherein the measurement information is generated using at least one of: CSI reference signal (CSI-RS) measurements, CSI interference management (CSI-IM) measurements, or synchronization signal block (SSB) measurements.
Aspect 7. The network entity of any of Aspects 1 to 6, wherein, to generate the measurement information, the processing system is configured to: determine, based on the measurement configuration, a configured time window corresponding to a set of reference signal (RS) measurement resources or interference management (IM) measurement resources for the aperiodic CSI report; monitor, according to the measurement configuration, the set of RS measurement resources or IM measurement resources during the configured time window to obtain one or more channel measurements; and generate the measurement information using the one or more channel measurements.
Aspect 8. The network entity of Aspect 7, wherein the measurement configuration is indicative of a set of aperiodic CSI reference signal (CSI-RS) or CSI interference management (CSI-IM) measurement occasions within the configured time window, and wherein the one or more channel measurements comprise respective measurements obtained for the set of CSI-RS or CSI-IM measurement occasions within the configured time window.
Aspect 9. The network entity of any of Aspects 7 to 8, wherein the processing system is configured to monitor the set of RS measurement resources or IM measurement resources only within the configured time window.
Aspect 10. The network entity of any of Aspects 1 to 9, wherein, to generate the measurement information, the processing system is configured to: obtain one or more channel measurements according to transmission timing offset information indicated by the measurement configuration, wherein the one or more channel measurements include at least one of CSI reference signal (CSI-RS) measurements or CSI interference management (CSI-IM) measurements; and generate the measurement information using the one or more channel measurements.
Aspect 11. The network entity of Aspect 10, wherein the processing system is configured to determine the transmission timing offset information relative to a slot associated with the first message or relative to a slot associated with the second message.
Aspect 12. The network entity of any of Aspects 1 to 11, wherein the first message comprises downlink control information (DCI) including an indication the request for the aperiodic CSI report is scheduled.
Aspect 13. The network entity of Aspect 12, wherein: the first message is an uplink (UL) DCI including an early indication field equal to a first value, wherein the first value corresponds to an UL DCI configuration for early indication of the request for the aperiodic CSI report; and the second message is an UL DCI including the early indication field equal to a second value, wherein the second value corresponds to an UL DCI configuration for the request for the aperiodic CSI report.
Aspect 14. The network entity of any of Aspects 12 to 13, wherein: the first message is a first uplink (UL) DCI received from a second network entity and the second message is a second UL DCI received from the second network entity; and the processing system is configured to identify the first UL DCI as an early indication of the request for the aperiodic CSI report based on corresponding aperiodic CSI trigger state information associated with the first UL DCI.
Aspect 15. The network entity of Aspect 14, wherein the first UL DCI is associated with an aperiodic CSI trigger state mapped to an aperiodic CSI trigger state index corresponding to the early indication, and wherein the second UL DCI is associated with an aperiodic CSI trigger state mapped to an aperiodic CSI trigger state index corresponding to the request.
Aspect 16. The network entity of any of Aspects 1 to 15, wherein the first message comprises a media access control (MAC) control element (MAC-CE), wherein the MAC-CE includes an indication the request for the aperiodic CSI report is scheduled, and wherein the MAC-CE includes an additional indication of a serving cell index.
Aspect 17. The network entity of any of Aspects 1 to 16, wherein the measurement configuration includes an indication of a particular aperiodic CSI trigger state value of a configured plurality of aperiodic CSI trigger state values.
Aspect 18. The network entity of any of Aspects 1 to 17, wherein: the measurement configuration is indicative of a configured time window corresponding to the measurement information; and to generate the measurement information, the processing system is configured to perform measurements of one or more configured reference signals received within the configured time window.
Aspect 19. The network entity of any of Aspects 1 to 18, wherein the processing system is configured to allocate computational resources to process the aperiodic CSI report using a start time associated with reception of the first message, or a start time corresponding to a first CSI resource within a configured time window indicated by the measurement configuration.
Aspect 20. A method for wireless communication, comprising: receiving a first message associated with an aperiodic channel state information (CSI) report, wherein the first message indicates a request for the aperiodic CSI report is scheduled; generating, based on a measurement configuration indicated by the first message, measurement information for the aperiodic CSI report; receiving a second message indicative of a request for the aperiodic CSI report; and transmitting, in response to the request, the aperiodic CSI report, wherein the aperiodic CSI report includes the measurement information.
Aspect 21. The method of Aspect 20, wherein: receiving the second message comprises receiving an uplink (UL) downlink control information (DCI) indicative of the request for the aperiodic CSI report, and decoding the UL DCI to determine the request for the aperiodic CSI report; and the measurement information is generated before the UL DCI is decoded.
Aspect 22. The method of any of Aspects 20 to 21, wherein the first message is an early indication of the request for the aperiodic CSI report.
Aspect 23. The method of any of Aspects 20 to 22, wherein the first message is associated with a first transmission time, and wherein the first message is indicative of an upcoming request for the aperiodic CSI report at a second transmission time later than the first transmission time.
Aspect 24. The method of any of Aspects 20 to 23, further comprising: receiving a radio resource control (RRC) message from a network entity, wherein the RRC message enables a configuration for aperiodic CSI reporting; and receiving the first message based on the configuration.
Aspect 25. The method of any of Aspects 20 to 24, wherein the measurement information is generated using at least one of: CSI reference signal (CSI-RS) measurements, CSI interference management (CSI-IM) measurements, or synchronization signal block (SSB) measurements.
Aspect 26. The method of any of Aspects 20 to 25, wherein generating the measurement information includes: determining, based on the measurement configuration, a configured time window corresponding to a set of reference signal (RS) measurement resources or interference management (IM) measurement resources for the aperiodic CSI report; monitoring, according to the measurement configuration, the set of RS measurement resources or IM measurement resources during the configured time window to obtain one or more channel measurements; and generating the measurement information using the one or more channel measurements.
Aspect 27. The method of Aspect 26, wherein the measurement configuration is indicative of a set of aperiodic CSI reference signal (CSI-RS) or CSI interference management (CSI-IM) measurement occasions within the configured time window, and wherein the one or more channel measurements comprise respective measurements obtained for the set of CSI-RS or CSI-IM measurement occasions within the configured time window.
Aspect 28. The method of any of Aspects 26 to 27, further comprising monitoring the set of RS measurement resources or IM measurement resources only within the configured time window.
Aspect 29. The method of any of Aspects 20 to 28, wherein generating the measurement information includes: obtaining one or more channel measurements according to transmission timing offset information indicated by the measurement configuration, wherein the one or more channel measurements include at least one of CSI reference signal (CSI-RS) measurements or CSI interference management (CSI-IM) measurements; and generating the measurement information using the one or more channel measurements.
Aspect 30. The method of Aspect 29, further comprising determining the transmission timing offset information relative to a slot associated with the first message or relative to a slot associated with the second message.
Aspect 31. The method of any of Aspects 20 to 30, wherein the first message comprises downlink control information (DCI) including an indication the request for the aperiodic CSI report is scheduled.
Aspect 32. The method of Aspect 31, wherein: the first message is an uplink (UL) DCI including an early indication field equal to a first value, wherein the first value corresponds to an UL DCI configuration for early indication of the request for the aperiodic CSI report; and the second message is an UL DCI including the early indication field equal to a second value, wherein the second value corresponds to an UL DCI configuration for the request for the aperiodic CSI report.
Aspect 33. The method of any of Aspects 31 to 32, wherein: the first message is a first uplink (UL) DCI received from a network entity and the second message is a second UL DCI received from the network entity; and the method further includes identifying the first UL DCI as an early indication of the request for the aperiodic CSI report based on corresponding aperiodic CSI trigger state information associated with the first UL DCI.
Aspect 34. The method of Aspect 33, wherein the first UL DCI is associated with an aperiodic CSI trigger state mapped to an aperiodic CSI trigger state index corresponding to the early indication, and wherein the second UL DCI is associated with an aperiodic CSI trigger state mapped to an aperiodic CSI trigger state index corresponding to the request.
Aspect 35. The method of any of Aspects 20 to 34, wherein the first message comprises a media access control (MAC) control element (MAC-CE), wherein the MAC-CE includes an indication the request for the aperiodic CSI report is scheduled, and wherein the MAC-CE includes an additional indication of a serving cell index.
Aspect 36. The method of any of Aspects 20 to 35, wherein the measurement configuration includes an indication of a particular aperiodic CSI trigger state value of a configured plurality of aperiodic CSI trigger state values.
Aspect 37. The method of any of Aspects 20 to 36, wherein: the measurement configuration is indicative of a configured time window corresponding to the measurement information; and generating the measurement information includes performing measurements of one or more configured reference signals received within the configured time window.
Aspect 38. The method of any of Aspects 20 to 37, further comprising allocating computational resources to process the aperiodic CSI report using a start time associated with reception of the first message, or a start time corresponding to a first CSI resource within a configured time window indicated by the measurement configuration.
Aspect 39. A non-transitory computer-readable storage medium comprising instructions stored thereon which, when executed by at least one processor, causes the at least one processor to perform operations according to any of Aspects 1 to 19.
Aspect 40. An apparatus for wireless communication comprising one or more means for performing operations according to any of Aspects 1 to 19.

What is claimed is:

1. A network entity for wireless communication, comprising:
a processing system configured to:
receive a first message associated with an aperiodic channel state information (CSI) report, wherein the first message indicates a request for the aperiodic CSI report is scheduled;
generate, based on a measurement configuration indicated by the first message, measurement information for the aperiodic CSI report;
receive a second message indicative of a request for the aperiodic CSI report; and
transmit, in response to the request, the aperiodic CSI report, wherein the aperiodic CSI report includes the measurement information.

2. The network entity of claim 1, wherein:
to receive the second message, the processing system is configured to receive an uplink (UL) downlink control information (DCI) indicative of the request for the aperiodic CSI report;
the processing system is configured to decode the UL DCI to determine the request for the aperiodic CSI report; and
the processing system is configured to generate the measurement information before the UL DCI is decoded.

3. The network entity of claim 1, wherein the first message is an early indication of the request for the aperiodic CSI report.

4. The network entity of claim 1, wherein the first message is associated with a first transmission time, and wherein the first message is indicative of an upcoming request for the aperiodic CSI report at a second transmission time later than the first transmission time.

5. The network entity of claim 1, wherein the processing system is configured to:
receive a radio resource control (RRC) message from a second network entity, wherein the RRC message enables a configuration for aperiodic CSI reporting; and
receive the first message based on the configuration.

6. The network entity of claim 1, wherein the measurement information is generated using at least one of: CSI reference signal (CSI-RS) measurements, CSI interference management (CSI-IM) measurements, or synchronization signal block (SSB) measurements.

7. The network entity of claim 1, wherein, to generate the measurement information, the processing system is configured to:
determine, based on the measurement configuration, a configured time window corresponding to a set of reference signal (RS) measurement resources or interference management (IM) measurement resources for the aperiodic CSI report;
monitor, according to the measurement configuration, the set of RS measurement resources or IM measurement resources during the configured time window to obtain one or more channel measurements; and
generate the measurement information using the one or more channel measurements.

8. The network entity of claim 7, wherein the measurement configuration is indicative of a set of aperiodic CSI reference signal (CSI-RS) or CSI interference management (CSI-IM) measurement occasions within the configured time window, and wherein the one or more channel measurements comprise respective measurements obtained for the set of CSI-RS or CSI-IM measurement occasions within the configured time window.

9. The network entity of claim 7, wherein the processing system is configured to monitor the set of RS measurement resources or IM measurement resources only within the configured time window.

10. The network entity of claim 1, wherein, to generate the measurement information, the processing system is configured to:
obtain one or more channel measurements according to transmission timing offset information indicated by the measurement configuration, wherein the one or more channel measurements include at least one of CSI reference signal (CSI-RS) measurements or CSI interference management (CSI-IM) measurements; and
generate the measurement information using the one or more channel measurements.

11. The network entity of claim 10, wherein the processing system is configured to determine the transmission timing offset information relative to a slot associated with the first message or relative to a slot associated with the second message.

12. The network entity of claim 1, wherein the first message comprises downlink control information (DCI) including an indication the request for the aperiodic CSI report is scheduled.

13. The network entity of claim 12, wherein:
the first message is an uplink (UL) DCI including an early indication field equal to a first value, wherein the first value corresponds to an UL DCI configuration for early indication of the request for the aperiodic CSI report; and
the second message is an UL DCI including the early indication field equal to a second value, wherein the second value corresponds to an UL DCI configuration for the request for the aperiodic CSI report.

14. The network entity of claim 12, wherein:
the first message is a first uplink (UL) DCI received from a second network entity and the second message is a second UL DCI received from the second network entity; and
the processing system is configured to identify the first UL DCI as an early indication of the request for the aperiodic CSI report based on corresponding aperiodic CSI trigger state information associated with the first UL DCI.

15. The network entity of claim 14, wherein the first UL DCI is associated with an aperiodic CSI trigger state mapped to an aperiodic CSI trigger state index corresponding to the early indication, and wherein the second UL DCI is associated with an aperiodic CSI trigger state mapped to an aperiodic CSI trigger state index corresponding to the request.

16. The network entity of claim 1, wherein the first message comprises a media access control (MAC) control element (MAC-CE), wherein the MAC-CE includes an indication the request for the aperiodic CSI report is scheduled, and wherein the MAC-CE includes an additional indication of a serving cell index.

17. The network entity of claim 1, wherein the measurement configuration includes an indication of a particular aperiodic CSI trigger state value of a configured plurality of aperiodic CSI trigger state values.

18. The network entity of claim 1, wherein:
the measurement configuration is indicative of a configured time window corresponding to the measurement information; and
to generate the measurement information, the processing system is configured to perform measurements of one or more configured reference signals received within the configured time window.

19. The network entity of claim 1, wherein the processing system is configured to allocate computational resources to process the aperiodic CSI report using a start time associated with reception of the first message, or a start time corresponding to a first CSI resource within a configured time window indicated by the measurement configuration.

20. A method for wireless communication, comprising:
receiving a first message associated with an aperiodic channel state information (CSI) report, wherein the first message indicates a request for the aperiodic CSI report is scheduled;
generating, based on a measurement configuration indicated by the first message, measurement information for the aperiodic CSI report;
receiving a second message indicative of a request for the aperiodic CSI report; and
transmitting, in response to the request, the aperiodic CSI report, wherein the aperiodic CSI report includes the measurement information.
